(19) United States
(12) Patent Application Publication
(10) Pub. No.: US 2015/0095243 A1
(43) Pub. Date: Apr. 2, 2015

(54) ONLINE-ID-HANDLING COMPUTER SYSTEM AND METHOD

(71) Applicant: Columba Online Identity Management GmbH, Berlin (DE)

(72) Inventors: Oliver EILER, Berlin (DE); Christopher EILER, Munchen (DE); Attila SIRMAN, Munchen (DE); Robert SCHMID, Munchen (DE); Wolfgang STADLER, Oberhaching (DE); Florian GAMPER, Berlin (DE)

(21) Appl. No.: 14/504,713

(22) Filed: Oct. 2, 2014

Related U.S. Application Data
(63) Continuation of application No. PCT/EP2013/056966, filed on Apr. 2, 2013.

(30) Foreign Application Priority Data
Apr. 2, 2012 (DE) 10 2012 102 867.2

(51) Int. Cl. G06Q 10/10; G06Q 50/18

(52) U.S. Cl. CPC G06Q 10/10; G06Q 50/186
USPC 705/312

(57) ABSTRACT

The invention as outlined below serves to introduce postmortem online identity handling that is capable of handling multiple clients. With this concept, the operator is able to create a Web or client application to delete the online identities of a deceased person with certified online providers. In the process, the deceased's contracts with online portals that require payment are canceled, existing credits are returned to heirs, or all other identifiable online accounts are deleted or deactivated.

### CROSS REFERENCE TO RELATED APPLICATIONS

This application is a continuation of International Application No. PCT/EP2013/056966, filed Apr. 2, 2013, which claims priority to German Application No. 10 2012 102 867.2, filed Apr. 2, 2012, the contents of each of which are incorporated by reference herein.

### FIELD OF THE INVENTION

The postmortem online identity handling services as described below document relate to a method of accommodating the ever-increasing demands arising after a complete life cycle of online identities. The procedures and technologies used for this purpose are referred to as “Columba,” which in the future should be regarded on the market as the reliable, serious, and effective brand for digital estate administration.

### BACKGROUND OF THE INVENTION AND PRIOR ART

Currently a large number of online identities are created on the Internet, but there is a lack of concrete and reliable processes and services that make it possible to regulate this digital estate in the event of death. In coming years the percentage of the deceased who used the Internet intensively during their lifetimes will rise continuously, which will lead to a sharp increase in demand for solutions that address this topic. It is to be expected that in the medium term lawmakers will call on the providers of online services for solutions.

### OBJECTS OF THE PRESENT INVENTION

The invention as outlined below serves to introduce postmortem online identity handling that is capable of handling multiple clients. With this concept, the operator is able to create a Web or client application to delete the online identities of a deceased person with certified online providers. In the process, the deceased's contracts with online portals that require payment are canceled, existing credits are returned to heirs, or all other identifiable online accounts are deleted or deactivated.

### SUMMARY

This and other objects are achieved by the systems and methods according to the claims.

Thus, for this purpose, Web-based services and desktop applications are created, which are implemented in appropriate technologies and programming languages. In order to implement long-lasting (persistent) data, integration with a database is necessary, which will be operated in a highly available and secured mode. Suitable technologies are selected as part of the detailed specification, and will be based on the requirements for dimensioning, performance, and availability of the systems.

To ensure the security and authenticity of personal and sensitive data, a deceased person's information and data are saved and transmitted exclusively in encrypted and signed form. Additionally, the accuracy of the information is verified with the responsible authorities.

In addition to the mandate issued by the survivors for the deletion of the deceased's online identities, the Columba procedure distinguishes itself by the direct cooperation with an agency for collecting deceased's data (in the following denoted as DDCA), and by an optional verification of the identity by a competent official authority. At the side of the online providers, their certification ensures that accounts with them are securely reconciled with the collected data of the Columba death register. Online accounts with Columba-certified partners are reliably discovered and resolved in the handling of a fatality, or any assets are returned to the survivors.

Columba also appeals to living persons who register to ensure that, in the event of their death, their online accounts will be handled according to interests they have determined themselves. The procedure can be used to ensure that all the accounts registered by the user are retrieved and closed. For online providers, Columba certification offers attractive added value for their customers, since it credibly conveys seriousness and transparency. The procedures described in this document refer conceptually to the case of death, but for users who are still alive the procedure can also basically be used to address the “right to be forgotten,” which is currently the subject of much discussion.

### ADVANTAGES

User's Objectives and Benefits

The deceased's dependents want the deceased's digital legacy to be cleaned up, taken over, liquidated, and clarified. If online assets are found, these should be given to the heirs.

Operators of online platforms want to clean up their databases and convey seriousness to their customers with a COLUMBA certification. It is in the interest of these providers to clean up their customer master data regularly and to label deceased persons in their database as such and to introduce necessary measures.

### BRIEF DESCRIPTION OF THE DRAWINGS

The invention along with several embodiments is described in greater detail with reference to the drawings. In the drawings:

FIG. 1 illustrates the entire process with its modular sub processes and the essential process steps;

FIG. 2 illustrates a schematic representation of the process;

FIG. 3 illustrates the data model;

FIG. 4 illustrates the process model;

FIG. 5 illustrates registered users;

FIG. 6 illustrates data management accounts search;

FIG. 7 is a graphical representation of the order management;

FIG. 8 is a graphical representation of the receipt of order;

FIG. 9 illustrates the validation process;

FIG. 10 illustrates process of data reconciliation

FIG. 11 illustrates data reconciliation variant 1 (Actively with the customer);

FIG. 12 illustrates data reconciliation variant 2 (Passively at Columba);

FIG. 13 illustrates data reconciliation variant 3 (Passively at the customer site with Columba API);

FIG. 14 illustrates data reconciliation variant 4 (Passively at the customer site without Columba API);

FIG. 15 illustrates data reconciliation Variant 5 (Passively at the customer site with Columba black box);

FIG. 16 illustrates the concept of separated autonomies;

FIG. 17 illustrates the Black box procedure;

FIG. 18 illustrates data reconciliation Variant 6 (Passively at the customer site with software engineering);

FIG. 19 illustrates the process of self-registration;

FIG. 20 illustrates the process of Registration;

FIG. 21 illustrates the Death diagram;

FIG. 22 illustrates the Encrypted tunnel; and

FIG. 23 illustrates the concept of Encrypted file.

### DETAILED DESCRIPTION OF THE PREFERRED EMBODIMENTS

Users/Target group are:
a. DDCA
b. Survivors of deceased persons who were active online during their lifetimes.
c. Operators on online portals.
d. Persons who want to manage their own digital estates while alive.

Overview of the Entire Process

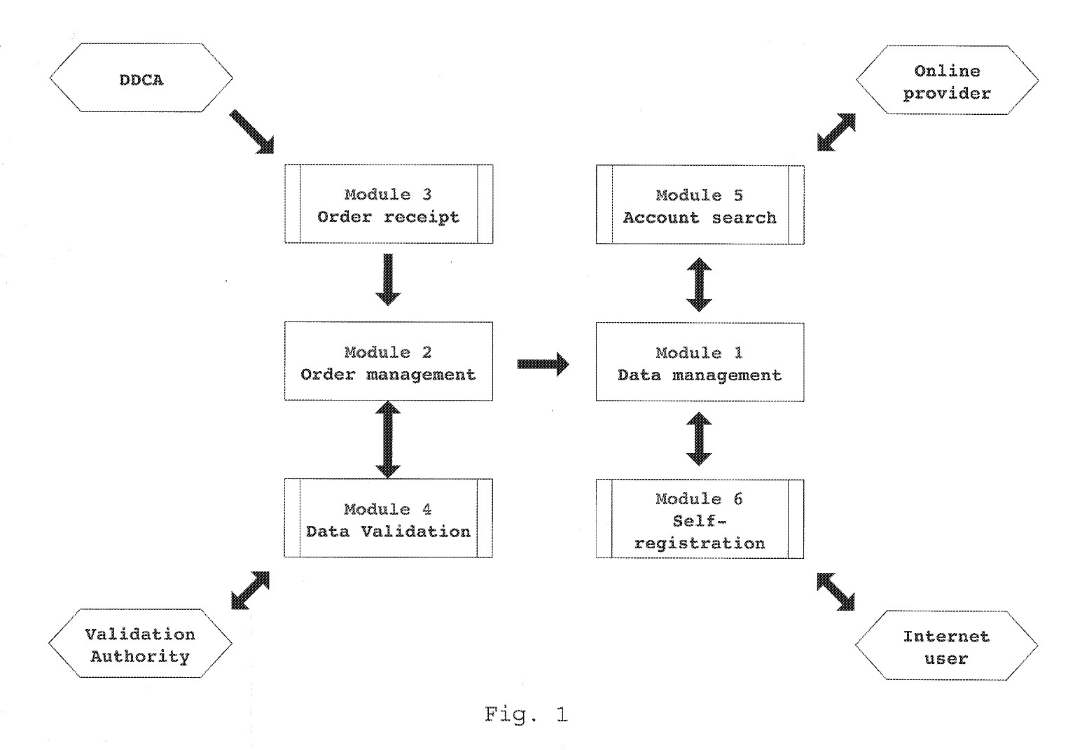

FIG. 1 illustrates the entire process with its modular sub processes and the essential process steps in powerfully abstract form. Using this illustration, the project can be divided into two main modules and four interface modules.

The central main modules are:
a. Module 1—Data management
b. Module 2—Order management.

The interface modules are:
a. Module 3—Receipt of order
b. Module 4—Data validation authority
c. Module 5—Accounts search (also reconciliation management)
d. Module 6—Self-registration.

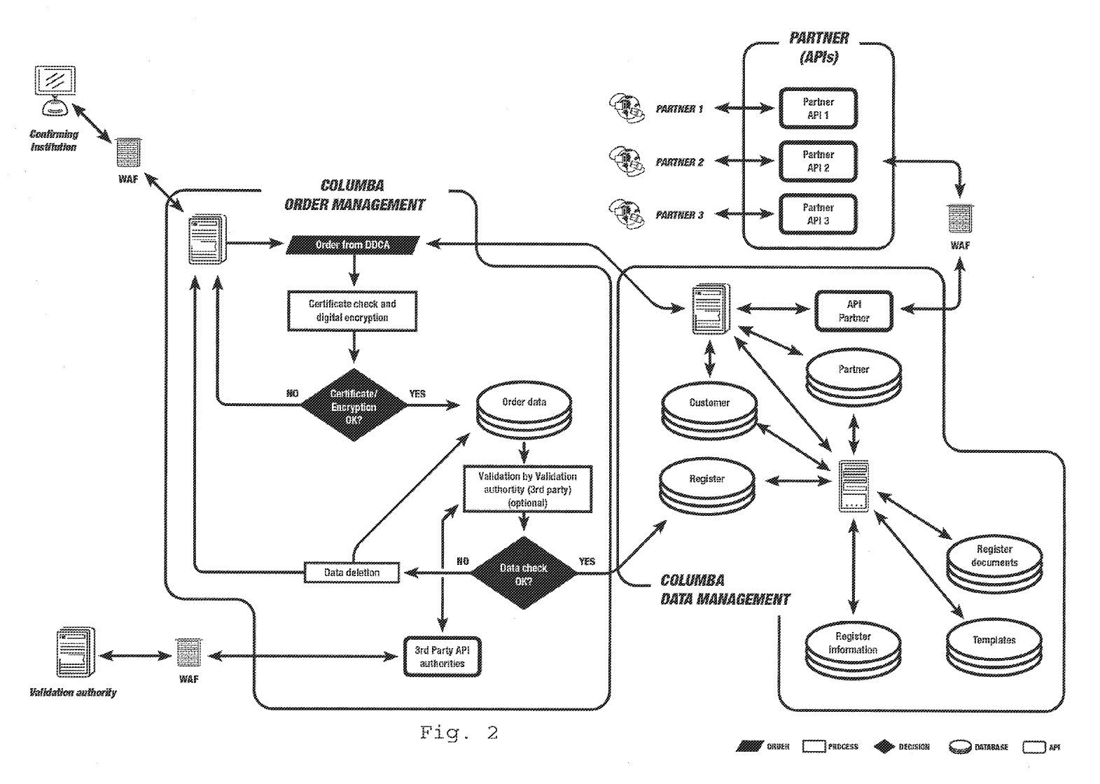

FIG. 2 is a schematic representation of the process.

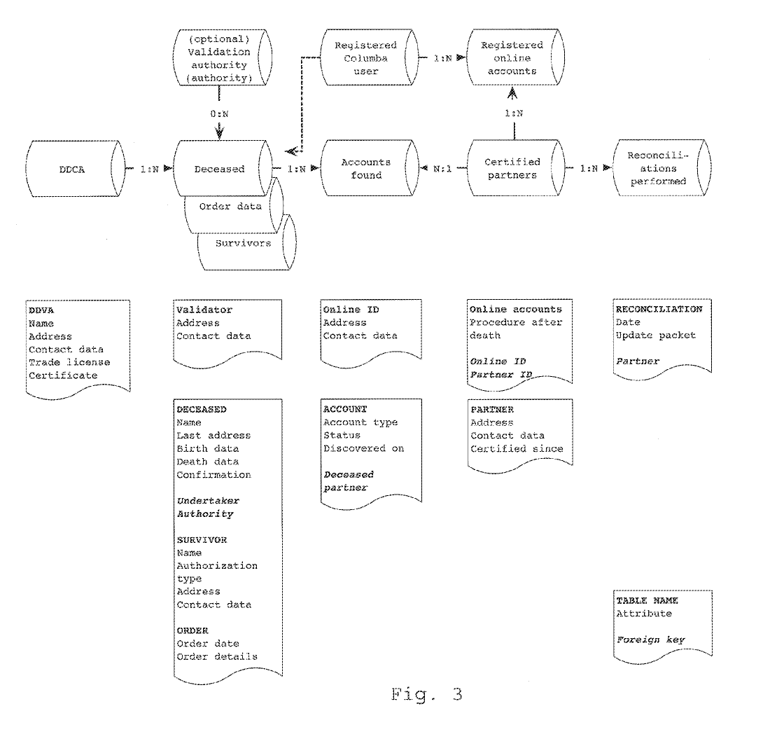

FIG. 3 illustrates the data model.

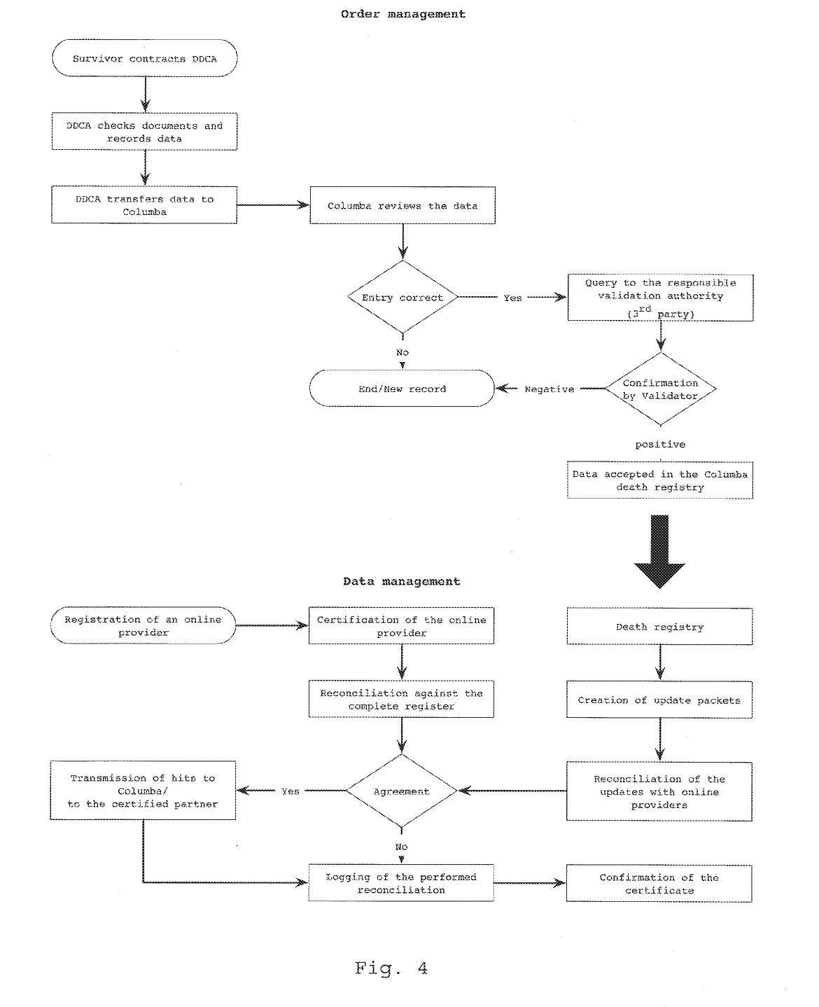

FIG. 4 illustrates the process model.

Roles and Responsibilities

In this section, the participating roles are named and described to continuously unify these roles in the following concept and to obtain clarity regarding their tasks, obligations, and rights.

Columba

As the service provider, Columba represents the organization that brings together the wish of the survivors for online accounts to be cleaned up and the interests of online platforms for cleaned-up customer directories.

Columba Back-End Operator

This role can be, but does not necessarily have to be, taken over by Columba itself. It refers to sites that contribute to providing the Columba service in operational processes, ensuring operation, and securing the quality of the service.

Registered Columba User

People who registered with Columba while they were still alive and registered their accounts with certified Columba partners using a Columba online ID. In the event of death, these accounts can be liquidated immediately according to the user's specifications.

Survivors

The survivor expresses the wish that a deceased person's online past be cleaned up. He/she is the end client of the service offered but, as a rule, is the client of a contractual partner (DDCA).

Authorized Survivor

Differs from the “survivor” in that he/she has verifiable proof of being authorized to administer, modify, and investigate the deceased's estate at the appropriate time.

DDCA

The DDCA is Columba's certified partner and offers the service to his/her customers (survivors). As part of his/her original function as DDCA, he/she is already responsible for process-relevant tasks such as identifying survivors and reviewing their documents (estate certificate, death certificate, identification papers).

Online Service Providers

Providers of online services that require registration by the user and, in the process, permanently save the user's personal data.

Examples: Web mail providers, social networks.

Online Service Provider with an Account Requiring Payment

This is a provider that demands a fee for the use of the services it offers (e.g. membership). This refers in particular to service providers who also charge if the service is not used. Examples: premium membership in social networks, online dating services, video and music subscriptions.

Online Service Providers with Accounts with Monetary Value

This refers to platforms that allow the registered user to deposit money into his/her account, which is then to be counted as part of the deceased person's estate. In addition to money accounts of whatever currency, this can also refer to an account with assets that are virtual but still have monetary value.

Examples: online banks, money transfer services, betting and gaming operators.

Authenticating Authorities

This refers to the locally (country, federal state, community) responsible authorities who officially confirm a person's death and, if applicable, can review the immediate estate planning. Particularly in the case of international mediation, this can be settled in a great number of different ways. Therefore this refers to the authority/location responsible for the respective death.

Example: in Germany these are the municipal registry offices.

Data Management—Module 1

The data management module contains the central database application for administering customers, partners, workflow templates, and the actual death registry. The module has defined interfaces for exchanging data between partners, for self-registration, and for order management. As soon as an order has been successfully validated, it is accepted by data management and marked in order management as having been transmitted. In the course of this transfer, all necessary workflows for this data set are automatically generated and started.

The database consists of the following main components:

| | | |
|---|---|---|
| a. | Death registry | (All accumulated deaths) |
| b. | Partners | (All registered partners) |
| c. | Hit | (So-called R-type between death registry |
| | | and partners) |
| d. | Self-registration | (Persons who use a Columba online ID) |
| e. | Registered online | (Online accounts that the user registered |
| | accounts | him-/herself) |
| f. | Survivors | |

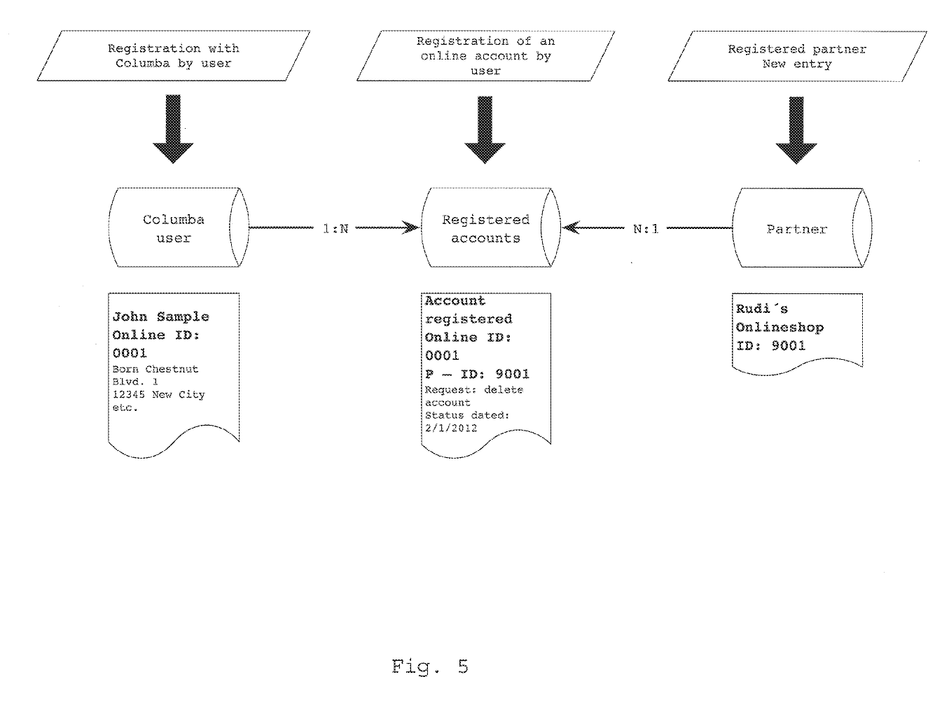

FIG. 5 illustrates registered users.

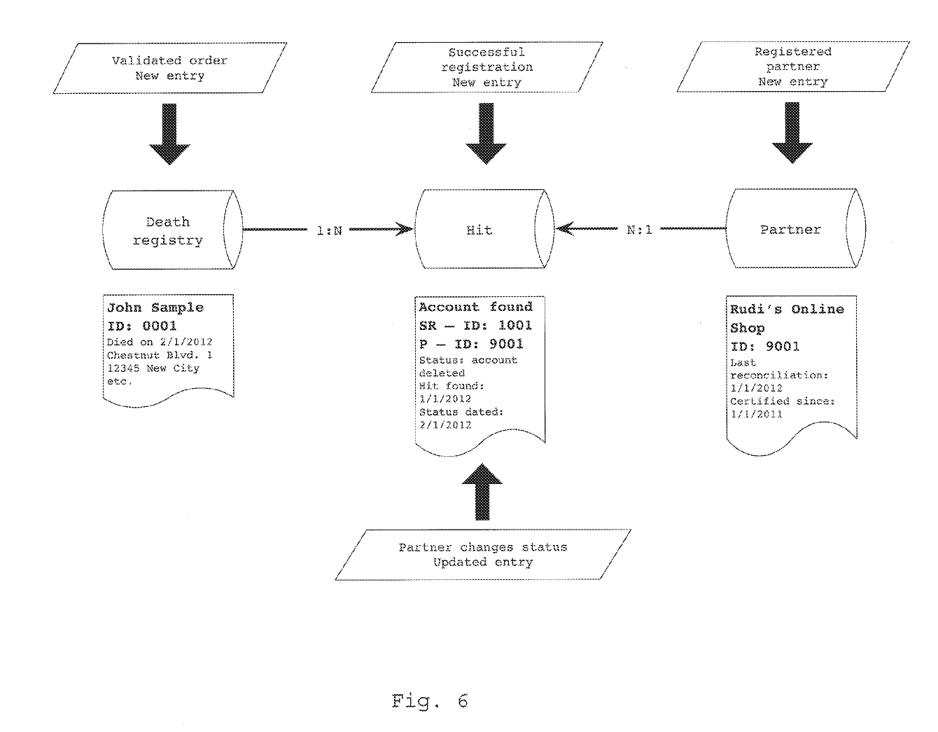

FIG. 6 illustrates data management accounts search.

Data Transfer from the Order

The incoming data set is legally validated by a third party. The data of the deceased is then transferred to the death registry. In the process, every death for which no Columba online ID was transmitted is compared against registered users of the online ID database. If the person is found there, the Columba ID is adopted.

When saving in data management, data is separated into individual tables in the same database or into self-sufficient databases differentiated according to:
a. Basic data such as academic title, nationality, first name(s), last name, address, place and date of birth, and Columba online ID, whose vulnerability is not to be classified as “particularly high.” (See the corresponding statements of data protection legislation)
b. E-mail addresses and other data that could be used specifically to identify online accounts but have no relevance outside the Internet.
c. Place of death, date of death, death certificate data. Data that must be assessed as particularly sensitive

Transmitted documents. These are also to be regarded as very sensitive and are to be handled accordingly.

Data Storage

The data that was transferred into the central death registry are chronologically provided with a time stamp so that partners only need to reconcile their databases with a death once. Because very large quantities of data are collected in the central registry, a very generous architecture should be chosen, and the corresponding dimensions of the subsequent implementation should also be very generous.

Because mandatory deletion of data sets is regulated according to the expiry of specific time periods (national provisions regarding data protection), the origin of the data and the time of saving must be logged. Because these time periods and the legal provisions on which they are based are subject to change, this dynamic should be planned for in the layout and in the data maintenance processes.

Technical Requirements

The death register is the Columba business model's central technical factor, and therefore this database must be:
a. Kept highly available;
b. Adequately dimensioned in terms of performance;
c. Appropriately protected against attacks;
d. Secured against manipulation; and
e. Treated as a strictly confidential business asset.

Data Documentation

The results of reconciliations performed with certified partners are to be documented in the data management; i.e. a log is kept:
a. Of which data set (bundled with update packets) is reconciled with which partner and when;
b. of which result came about in the review, with only hits being recorded;
c. which actions/which status were/was fed back to the found accounts by the online operator (with time offset if applicable).

This information serves both as proof of activity and for internal process management.

In this way, it is possible to demonstrate to the customer in detail (DDCA, survivors (if applicable)) what his/her commissioning brought about, which accounts could be found, and which actions were introduced as a result. It should be expected that the commissioning party will not want to be confronted with the results of the research against his/her will.

This data must also be saved as proof to the certifying partner in case of later complaints or an emerging need for clarification.

The results of the research can trigger certain actions (processes) that are managed centrally via data management. These include:
a. Handing over information to third parties, e.g., debt collection agencies or trustees that help to return assets;
b. Introducing formal cancellations in cases where it is not possible to initiate all-inclusive cancellation processes (here, too, third parties can do this, if necessary).

Interfaces

The central data management includes functional interfaces to the partners and to order management. These interfaces are defined, prepared, and operated by Columba in the design phase.

It should be noted that maintenance and service interfaces that are necessary for operating the systems and corresponding database software will be described precisely as part of the operating concept and provided with quality assurance measures in operation.

Interface Order Management

Communication between Modules 1 and 2 is to be regarded as internal communication and must therefore be realized securely and effectively. If redundant computer centers are used, the data connection between the individual sites must be provided with a high degree of security and, if possible, should also be designed redundantly.

Current Changes to the Account Search Interface

This interface provides the partners with data for comparison with the databases. Insofar as the black-box procedure or a software expansion module (see chapter 0, 0) is used, due to consideration of the legal data protection provisions and Columba's sole data sovereignty, at no time will these data be accessible to the partner as plain text. The Columba black box or the software module appears to the partner as the immediate recipient of the data provided.

With regard to security, this means that the data leave the internal data management system (core) exclusively in secured form. This is achieved first through the encryption of the data themselves, and second through a secured connection between data management and the black box.

Even if a certification partner has not performed a reconciliation for a long time, all data sets accumulated to that point are provided to him/her for reconciliation as (weekly) packets.

The complete and correct transfer of data sets can be determined at the black box, since the packets are provided with a sequential ID and have a signature. There is a central review of which partner is in which alignment state so that the partner can be contacted in case of a delay to eliminate the cause of the delay.

The data are filed in an encrypted file in the local Columba file system (within the black box) and processed there. A suitable data format and access method is used; from today's perspective, this could be XML, SOAP, or similar formats, for example.

The data transmitted to the local black box with the online provider serve the search for matches in the database by reconciling attributes that are suitable for making possible an unequivocal identification of the underlying person. For Germany, the characteristics are:
a. Academic title
b. First name(s) and last name
c. Gender
d. Place and date of birth
e. Date of death
f. Address (street, street number, postal code, city) of the last residence
g. Nationality
h. Columba online ID, if available

In the international view, additional country-specific characteristics are available, for example:
a. Tax number
b. Debtor number
c. Identification number
d. Etc.

The transmitted data corresponds to the minimum requirements for unequivocally identifying a person, as is also customary for registration of residents' information, for example.

From the point of view of data protection, the saved personal data is only to be rated as of “limited sensitivity.” The special need for data protection is based on the information that the person concerned is deceased.

Interface for Accounts Search of the Total Inventory

Functionality corresponds to that of the interface described before to the difference that not only newly added data sets are made available, but also all preceding data packets.

The reasons for this are service related, since newly gained partners should first reconcile their databases with the total inventory of the Columba death register. This is for securing the integrity of the transmission in a proprietary procedure.

Interface for Partner Data Transmission (Feedback)

It is necessary both for internal and external reporting of the hits obtained (agreement between online accounts and deaths) that the partners convey the status of the performed reconciliation to Columba.

First, the following data are immediately transmitted to Columba as part of the successfully completed reconciliation of the data at the online provider:
a. The Columba partner's ID;
b. The ID of the processed data packet, reconciliation date;
c. The list of the IDs that could be assigned to one of the online provider's customer data sets (including the probability value of the agreement).

The fact that the Columba data set was reconciled without finding an agreement must not be saved explicitly since this information can be deduced from the logging of the successfully reconciled data packets and the Columba partner's ID.

For the partner firms, the corresponding data sets (and only these) are also made available through the black-box procedure, but this time in unencrypted form. Due to the time delay between reconciliation in the black-box procedure and the action performed (deletion/deactivation, assets available, contract available, dissolution), it is necessary that the final status can be transmitted to Columba at a later time as a supplement. This is performed via a defined interface of the black box, through which the data set ID and a defined status code are transmitted to Columba. On Columba's side, when this information is received, the associated data set of the tuple (deceased/online provider), which has already been applied as a “hit,” is correspondingly updated/supplemented in the status.

The deceased's personal data are not transmitted again; the IDs supplemented with a status code are sufficient. Via a server port, the interface receives data sets consisting of Columba ID, partner ID, and the status of processing by the partner, which is assigned and saved in the Columba data management. The data described are less confidential, which makes the correctness of the data in the transmission to Columba that much more important.

Interface Self-Registration (Module 6)

It is possible to register with Columba so that a “digital estate” can be regulated while a person is still alive. For more details, refer to chapter “Module 6 Self Registration below in this document.

The user is given the ability to enter his/her own data when registering and also to maintain this information later and keep it up to date. Additionally, the user can use the Columba ID accounts assigned to him/her to register with online service providers and, if applicable, to specify what should happen with this account in the event of his/her death. For this purpose, a Web interface is made available to the user, which he/she can use to attend to the tasks mentioned.

Additionally, the Web interface should provide him/her with an overview of the Columba-certified companies with which he/she has registered an account. If one of these account registrations should be deleted, this can be done immediately (for whatever reason the user wants to do this). If the user wants to completely dissolve the online account, a link will be made available that refers to the online provider's corresponding page. In this way, the user has the opportunity to maintain an overview of his/her online accounts.

Order Management—Module 2

Columba order management administers incoming orders, reviews them, and initiates validation. Depending on the result of the reviews, the orders are rejected, returned for revision, or transferred to data management (death register) if successful.

Data transmitted to Columba are reconciled with the responsible authorities and transferred to Columba data management if validation is successful. Otherwise the data in order management are marked for deletion and the ordering parties are notified accordingly.

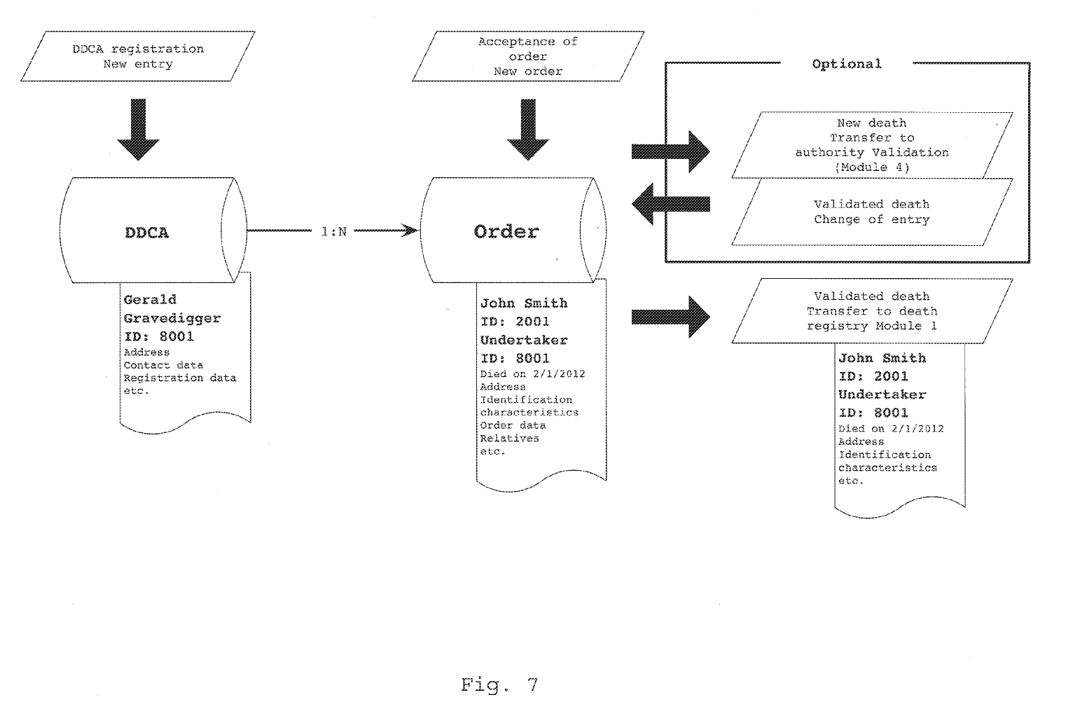

FIG. 7 is a graphical representation of the order management.

Data Storage

If the certificate used for entering and transmitting data and the digital signature are valid, the received data are transferred into the Columba order database.

If the order was made directly by a survivor, both the notifying party's legally binding identification and his/her authorization to place an order (estate certificate, death certificate, etc.) must be securely verified.

For purposes of clarity, all order data in the graphic shown above were rendered as a schematically represented database table. In the implementation of the project there is a review to determine if personal data from orders should be saved in distributed form in different databases (tables).

For the current planning stage the table structure can be indicated as follows:

| a. | Contracts | | |
|---|---|---|---|
| | | i. | (ContractOID, TransmissionID, TransmissionDate, |
| | | | TransmissionTime, CustomerOID) |
| b. | Persons | | |
| | | i. | (PersonOID, ContractOID, ac. Title, Firstname, Last |
| | | | Lastname, ZipCode, City, Country, Address) |
| c. | PersonsInfo | | |
| | | i. | (ContractOID, Birthdate, Birthplace, DayOfDeath, |
| | | | PlaceOfDeath, NumberDeathCertificate, |
| | | | DateDeathCertificate, NamePublicAuthority, |
| | | | PlacePublicAuthority) |
| d. | PersonsEmails | | |
| | | i. | (ContractOID, Email) |

| | |
|---|---|
| e. | Order interface for DDCAs. |

The Columba order interface for DDCAs represents the connection for recording data sets from registered DDCAs and is described in more detail below. It verifies in real time whether the sent certificate and the digital signature are valid; otherwise it refuses to accept the data. If the certificate or the digital signature is invalid, the DDCA is informed via his/her software's transmission protocol and the process ends. No data are applied in the system.

Specification of the Interface

The technical specification of the interface is part of the beta development and is determined to a large extent by the data to be transmitted. A standard solution should be chosen here

Order Interface for Survivors

The Columba order interface for survivors represents the connection for recording data sets from survivors and is described in the following chapter (Module 3). If it is not possible to process the data, the survivor is notified of the error via the e-mail address he/she provided when placing the order and the process ends.

Specification of the Interface

The technical specification of the interface is part of the beta development and is determined to a large extent by the data to be transmitted. For protecting the interfaces against attacks, a proprietary protocol is used.

Process Description for DDCAs

For an undertaking company to be able to apply to order management for the deletion of online identities, the undertaking company must first register with Columba. Undertaking companies must register successfully before they are able to transmit orders from survivors to Columba for the deletion of online identities.

As part of the order recording by the DDCA, there is a review of the documents presented (death certificate, estate certificate, etc.) which a DDCA generally is able to do.

The transmitted data may be validated by third parties (e.g., by official authorities) prior to taking it over. This is country specific.

DDCA Registration

A DDCA will be able to register the first time via the Columba Web site. On this page there will be an open registration and a login to a closed area for undertaking companies. Two scenarios should be considered for the registration:

The DDCA is an individual enterprise with only one location

or

The DDCA is a large company with multiple branch offices

In the second case there is exactly one ordering party who takes on administrative processes and responsibilities independent of how many branch offices and employees will be authorized to functionally use the order interface.

Documents, software, dongles, etc. are sent to the central company address and distributed in the company from there.

After the DDCA has successfully registered online and his/her identity has been appropriately verified, he/she receives a confirmation of his/her registration. Even a DDCA which is not familiar with technology should be able to use the Columba service securely and without errors.

Receipt of Order—Module 3

The receipt of order module describes the functionalities and technical requirements that are used to create customer orders and transfer them to order management. Alternatively, there is a description of how orders issued directly by the survivors are processed.

The two interfaces differ both conceptually and in their technical specifications:
a. The undertaking company has a software program into which certificate-based authentication and encryption methods have been integrated to ensure the integrity and security at, before, and during transmission to Columba—Columba knows the identity of the notifying site.
b. The survivor him-/herself does not have such a software program; he/she operates over a Web interface. The identity of the notifying party is not verified.

In the DDCA/desktop application variant, the digital certificate (which may be on a dongle) that was used to transmit the orders is checked. Further validation of the data continues only if this certificate is valid. If the certificate is invalid or if it has expired, the customer is informed of this and the connection for data transmission is rejected.

The service may be temporarily or permanently cut off for customers whose orders repeatedly exhibit unsatisfactory data quality or whose verification with the authorities fails regularly.

In the private user/survivor variant, data are transmitted via a secure encrypted Internet connection (https:) using a Web application.

In this case, it is difficult to identify the ordering party because the user was not verified in advance. In the medium to long term, personal digital identification can be considered as an option for identifying the ordering party, but to date this procedure cannot be successfully implemented for technical reasons. The rest of the procedure for data transmission is identical with the DDCA variant.

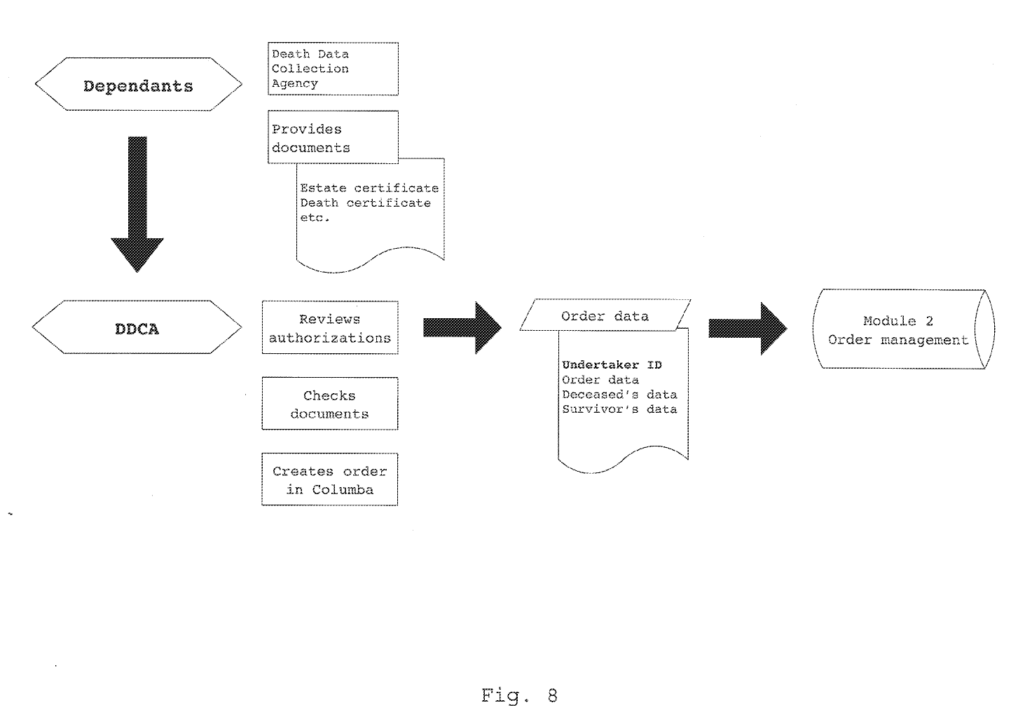

FIG. 8 is a graphical representation of the receipt of order.

DDCAs can apply for the cleaning up and, if applicable, deletion of a deceased person's online identities if they have a power of attorney from those entitled to inherit. DDCAs can make these applications via a desktop software program developed for this request. The application makes it possible to administer orders easily. One way to obtain the software is over the Internet via a download area. Alternatively, it can be written directly onto the certificate dongle and distributed with it. The software should include an update mechanism so that future program updates can be automatically distributed to the undertaking companies and installed there.

If the software is to be obtained via the download area, the user must also obtain a valid certificate and an activation code. This certificate is delivered on a dongle, a chip card, or a comparable immutable storage medium. The DDCA can begin administering orders only after the software has been installed without errors and a valid certificate is present.

To allow for a secure exchange of data with the Columba order administration, the data are digitally encrypted during communication with the Columba server and during transfer over the Internet. Data is transferred over a proprietary protocol developed by Columba. Instead, a hardware-based solution may be applied.

Following a successful transfer of an order to Columba's order management, the order is marked as “transferred” in the DDCA's client application and filed appropriately. However, only the data that the DDCA needs to represent his/her business relationship to the survivor remain on the DDCA's computer (if applicable, for financial authorities, defense against complaints, and claims for compensation against the DDCA).

To ensure a history of orders, a transfer log containing the relevant information is sent to the DDCA from Columba order administration. All orders given can be reconstructed and documented via the log file.

A Web application should be developed and made available for survivors that accepts the directly entered order in a comparable way. In the verification of the identity of the survivor (ordering party) and in the review of his/her eligibility to order the deletion of the deceased's online identities, procedures are used that have already been established on the market (e.g. Postident procedure).

Software for DDCAs

The client software will run on the undertaking company's local computer and should therefore be developed for platforms that are to be found on the market (e.g. Windows, MacOS, Linux). It includes user interfaces for data entry and data display. It also automatically creates the digital signature for the data transfer to the Columba order administration to ensure that the data cannot be changed after this point in time. When starting, the application checks independently to see if the certificate is available and valid. If this is not the case, the DDCA is informed via an appropriate notification and the application is closed automatically following confirmation.

The layout of the application must be kept simple and it must be easy to learn to operate. All input and output masks can be reached directly via a menu structure. The dialogs should not be written in technical language. The software checks independently and at regular intervals to see if an update is available on the Columba server and installs this update following confirmation by the user.

The application can be used either with an online connection to the Columba server or in an “offline mode” without an Internet connection.

Installation Routine

The software can be made available to the DDCA via the Columba Internet portal's download area or alternatively provided to the DDCA on a dongle together with the digital certificate.

The customer should be guided through the installation process with the help of the software installation package. He/she can select the installation folder as well as the creation of a desktop symbol. The customer is informed of the individual steps and the success of the installation.

Input Mask

The DDCA can easily enter the necessary master information via the input mask. The data is checked for completeness, plausibility, and data formats. The data can only be saved for further processing after they have been correctly entered. All entry fields are required information.

Order Mask

Via the display form, the DDCA can review all orders that have not yet been approved. The customer has the option of using filters to limit the display, which makes it easier to find orders. He/she also has the option of correcting the orders. The “Approve” button initiates the transmission of filtered orders to order management. After transmission, the DDCA receives a status update for each individual order as well as a confirmation of transmission. This contains information on whether the transfer was free of errors. Orders that are transmitted without any disturbance are automatically marked as concluded and can no longer be edited. If an order is to be processed, the input mask is opened for the selected order and all input fields, as well as the deposited documents, are filled out in advance.
a. Filters:
b. Gender
c. First name
d. Last name
e. Date of birth
f. Place of birth
g. Place of death
h. Date of death
i. Death certificate number
j. Location of the authority
k. Date of issue by the authority
l. Buttons:
m. Process selected order
n. Approve orders
o. Close

Order Transmission for DDCAs

Order transmission consists of the following steps:
a. With the Columba software and the required digital certificate, the DDCA can first record detailed cases of death locally.
b. At the instigation of the DDCA, the recorded cases of death are transferred to the Columba order system with the deceased's data by means of the secured connection and are logged with the DDCA.
c. The transferred data are provided with a digital signature while they are still with the DDCA so that they cannot be manipulated at a later point in time.
d. The DDCA receives a transmission confirmation (for each order and with information on the data transferred) immediately after the transmission. This is also done in encrypted form.
e. This concludes the DDCA's active notification to the Columba system.
f. Data are checked by reconciling the death data with the responsible authority (see section “Data validation by authority)).
g. In case validation fails:
   i. The order is marked accordingly by Columba;
   ii. The DDCA receives a notification that he/she should review his/her data and, if applicable, record them again, as well as a notification the order is not being carried out;
   iii. The operation is logged and, if applicable, settled. Regulations must be defined for settling that can be designed in ways that are specific to countries or business models.
h. In case validation succeeds:
   i. The order (death data) is transferred into Columba data management (central register);
   ii. The DDCA receives a confirmation that his/her order has been reviewed positively and is now being carried out. This log remains with the DDCA.

Log Mask

To enable the customer to document which orders he/she transmitted, the saved log files is shown in a list. Filters are made available to limit the data.

Process Description for Survivors

For a survivor to be able to apply to order management for the deletion of his/her relative's online identities, he/she must first call up the Columba Web application in his/her Web browser. As part of the placement of the order, the identity to be canceled must be established. Accordingly, identification via his/her address data accompanied by a double opt-in and a CAPTCHA is reasonable. After the form has been completed with the deceased's data, the death certificate, and the certificate of inheritance, the survivors can transmit the application for the deletion of the online identities to Columba.

The ordering party receives an order number via e-mail as well as an access code, which he/she can use on the Columba Web application at any time to obtain information about the status of his/her order.

From that point, Columba processes the order similarly to the way it processes the DDCA order, with the difference that incorrect data validations are transmitted to the ordering party via e-mail.

Identification of Survivors

If a survivor opens the Web application in his/her browser, he/she is prompted to enter his/her personal data, address, and availability. After confirming the CAPTCHA, he/she can send this information to Columba, after which he/she will receive an e-mail with the registration code (link) authorizing him/her to enter the deceased's data.

Input Mask

The user can enter the necessary master information via the input mask. The data are checked for completeness and plausibility. If all the data have been entered correctly, they can be saved for further processing. All entry fields are required information.

Order Transmission for Survivors

Order transmission consists of the following steps:
a. The survivor can record the death data in the input mask.
b. The recorded order with his/her information is displayed to the survivor once again for review. He/she will only be routed to the payment module after he/she has confirmed the accuracy of the data entered.
c. In the payment module, he/she can make the payment online via immediate bank transfer, credit card payment, PayPal, etc. The payment data are checked immediately for accuracy.
d. Data are only transmitted to the Columba order system via the secured connection if the payment provider successfully confirms the payment, and the status “Payment due” appears until the payment has been received.
e. Immediately after the transmission, the survivor receives a transmission log via e-mail as confirmation of receipt.
f. This concludes the survivor's active notification to the Columba system.
g. Before the order is transferred for reconciliation with the authorities, it requires a complete debt collection procedure (recording of receipt of payment, classification, dunning levels, etc.).
h. If debt collection fails, the data set is marked for deletion and the survivor is informed of this. The order transmission process ends.
i. Paid orders are validated by reconciling the death data with the responsible authority.
j. In case validation fails:
   i. The survivor receives a notification with the exact reason and an edit code that makes it possible to change the recorded data;
   ii. The ordering party's corrected data are amended in Columba;
   iii. The changed data is re-evaluated;
k. The procedure is logged.

In case of an irrevocably failed validation:
a. The data is deleted;
b. The survivor receives a notification with the information that the data were not validated by the authority and the order cannot be carried out.

In case validation succeeds:
a. The order (death data) is transferred into Columba data management (central register);
b. The survivor receives a confirmation that his/her order is OK and is now being carried out.

Data Validation by Trustable Third Parties—Module 4

An essential characteristic of postmortem identity management by Columba is the reliability and resilience of the information used. Therefore it is intended that no data will be accepted into the Columba death register unless their authenticity has been validated by a trustable third party. In this way, it is ensured that online accounts or the general interests of still-living persons cannot be damaged, even if the acting parties have a criminal background.

Every individual order is confirmed by a trustable third party that is able to do this. In Germany, these are e.g., the registry offices/registrar's offices.

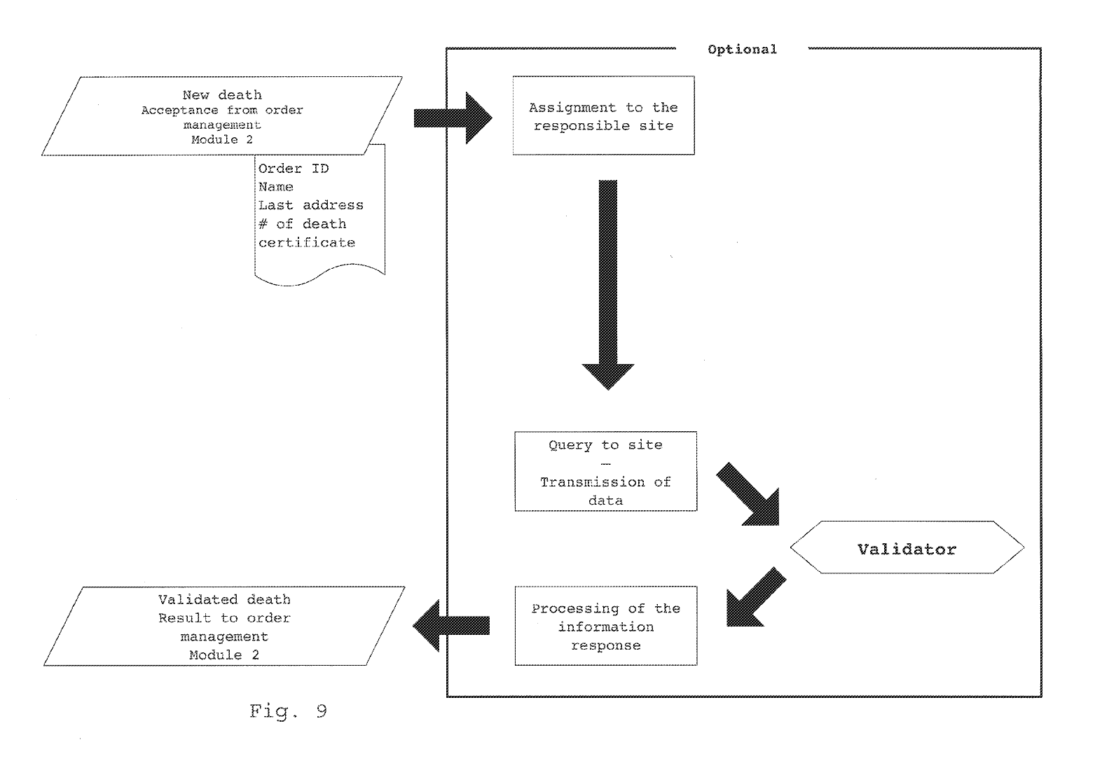

FIG. 9 illustrates the validation process.

Interface for Authority

This interface serves exclusively to verify the death data transmitted by the DDCA or those entitled to inherit. Official validation ensures that the person indicated is actually dead. This is necessary to prevent any abuse that could lead to the deletion of the online identities of living persons.

Actual cooperation with the respective authorities is an issue of legal as well as administrative regulations, which are to be met in a wide variety of different ways. Because there are e.g., online service providers who verifiably access central registration offices, it can be assumed that it will also be possible for Columba to establish e.g., a solution with the authorities.

A Columba API is provided that continuously reconciles the data saved in the order database with the databases of third parties. In the process, it is asked if the first name, last name, date of birth, place of birth, date of death, place of death as well as number and the date of issue correspond with the death certificate.

For this purpose the required information is transferred to the pertinent interface, which communicates with the respective registers third parties. This data must be transmitted in encrypted form (confidentiality) and must be protected against manipulation (integrity).

The confirming site answers with a status report and, in case of a negative reply, with an error code that makes it possible to deduce the reason (unsatisfactory data quality, person is not dead, person does not exist, etc.).

Accounts Search—Module 5

The search for deceased persons' accounts in online portals is an essential characteristic of the procedure developed by Columba and must be emphasized.

Certified Online Portals

For the online portals to be able to reconcile their customer data with the Columba register, they must first be certified with Columba.

Communication between Columba and online operators is based on multiple interfaces. It is ensured that all interfaces used correspond to the best security standards at the present time and possess a trustworthy architecture for both sides.

To obtain a Columba certification as an online provider and to keep it over the long term, it is necessary for the partner to comply with the provisions and rules defined by Columba.

These relate to the regularity of data reconciliation, the time it takes the partner to react to found accounts, and the quality of the processing of such online identities, among other considerations. Columba reserves the right to perform appropriate and effective inspections to ensure quality and performance. The partner companies declare that they agree with these inspections; otherwise certification cannot be granted or must be revoked.

Because the entire challenge of the planned data reconciliation lies in the question of the position of trust, several variants are compared. Advantages and disadvantages are pointed out, and in one of the next project steps, project management should remove unsuitable procedures from the project focus and only allow promising procedures to be further analyzed and refined.

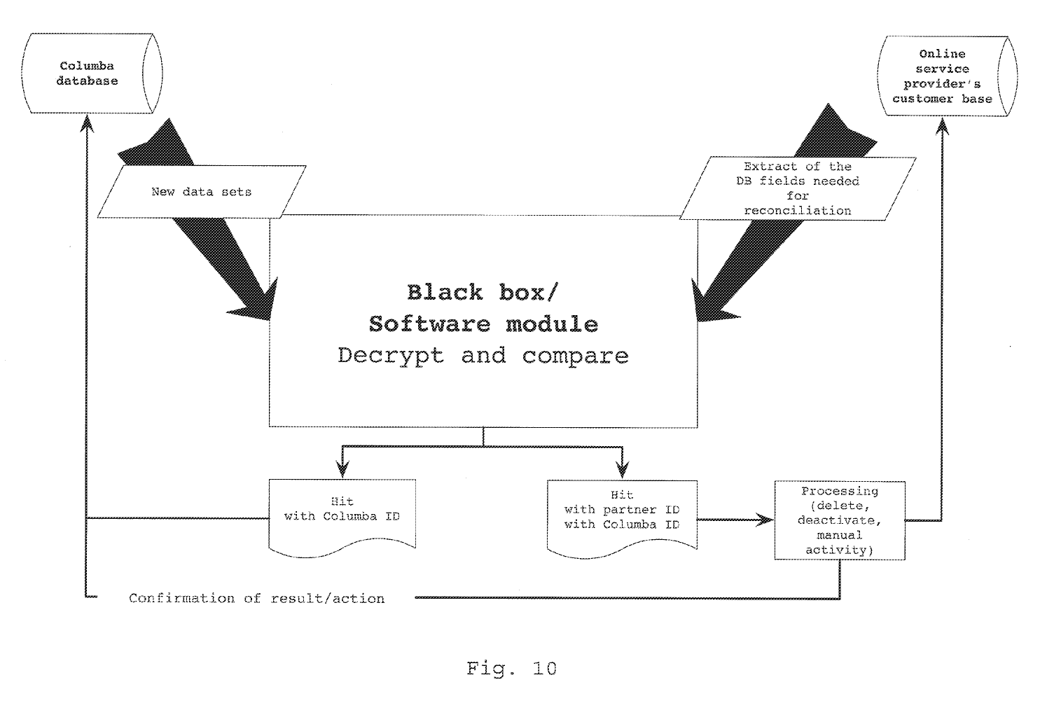

FIG. 10 illustrates the process of data reconciliation. The different module variants of the are illustrated and described below

Registration of Partners

Reconciling the online provider's customer master data with Columba's necrologies will only be possible for certified partners. Therefore, the partner must be bindingly registered and certified. As part of the certification, the partner (online provider) must declare in writing that it will only use the information made available to him/her for the purposes agreed upon (deaths in its client base).

When partners register with Columba they receive:
a. Their own partner ID
b. Login data by mail
c. Activation code by separate mail
d. The digital certificate created by Columba
e. Access to a black box (if applicable, software- or hardware-based, depending on need).

Variant 1—Actively with the Customer

Data reconciliation is started actively by Columba and is performed with the customer

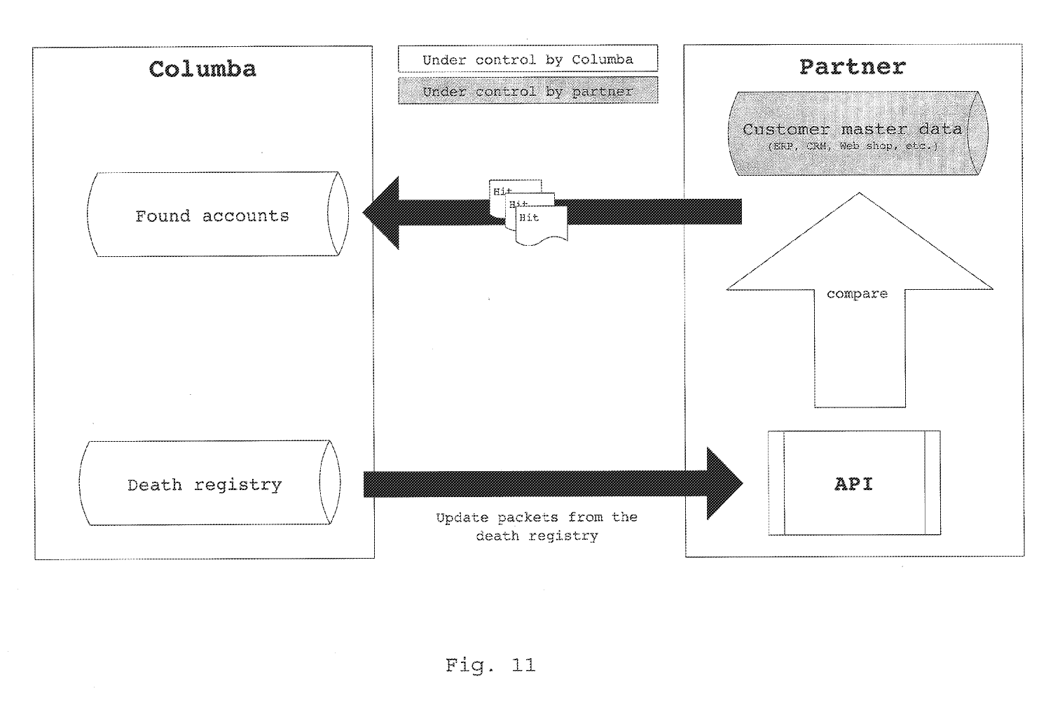

FIG. 11 illustrates variant 1.

The starting point is the desire for the deletion of the deceased's online identities, which is expressed as an order by the survivors with the DDCA. The data deletion is actively initiated in the participating partners' customer master data.

Via the API to be implemented by the partner, the death data validated by Columba with the responsible authority are sent to this partner together with a deletion request. The following steps performed by the partner are documented in the Columba data management via the Columba API. The individual steps:

Via the partner API, Columba transmits an ID, a Columba ID if available, academic title, nationality, first names, last name, address, date of birth, place of birth, place of death, and date of death to the partner.

If the person is found in the partner's database, the partner transmits the hit (as a status code) via the Columba API in connection with the ID (from the query).

If the person's data are then deleted or placed in a corresponding status, the partner also transmits this information via the Columba API as a status code in connection with the ID.

If there are no hits, the partner reports this back as the status code and ID of the certified partner, also via the Columba API.

This process is concluded for the respective partner only if the partner reports the status as either “deleted” or “not found.” Until then, it remains an active process (queries may be repeated after a certain amount of time).

Variant 2—Passively at Columba

Data reconciliation is started passively by customer inquiry, and reconciliation is performed at Columba.

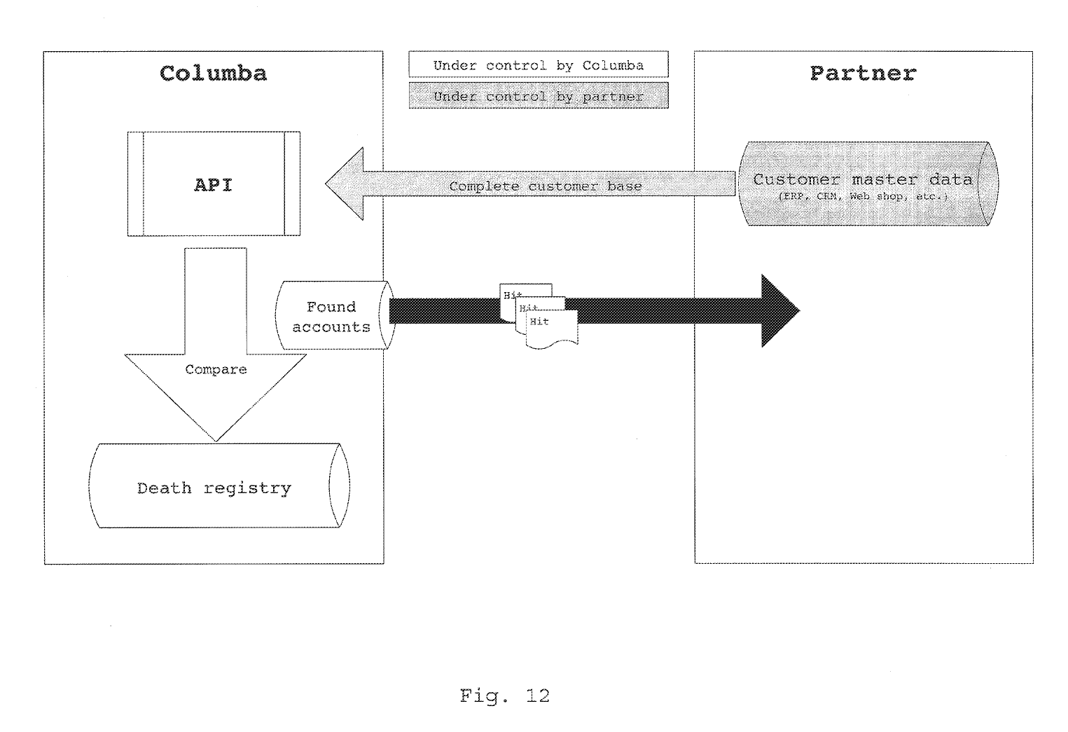

FIG. 12 illustrates variant 2.

Another option for data reconciliation lies in providing a “death registry,” in which the partners can query themselves if their databases are current with regard to deceased members.

The partner transmits its entire database to Columba via the Columba API. If hits are obtained in the Columba death registry on the basis of the transmitted data, these data are filtered out of the transmitted database and sent back to the partner as a reply. It can assign the hits to its data sets using a transmitted identifier and in this way initiate the deletion/deactivation of the data sets.

Variant 3—Passively at the Customer Site with Columba API

Data reconciliation is initiated passively through customer query; data are reconciled by the partner with an API that originates from Columba.

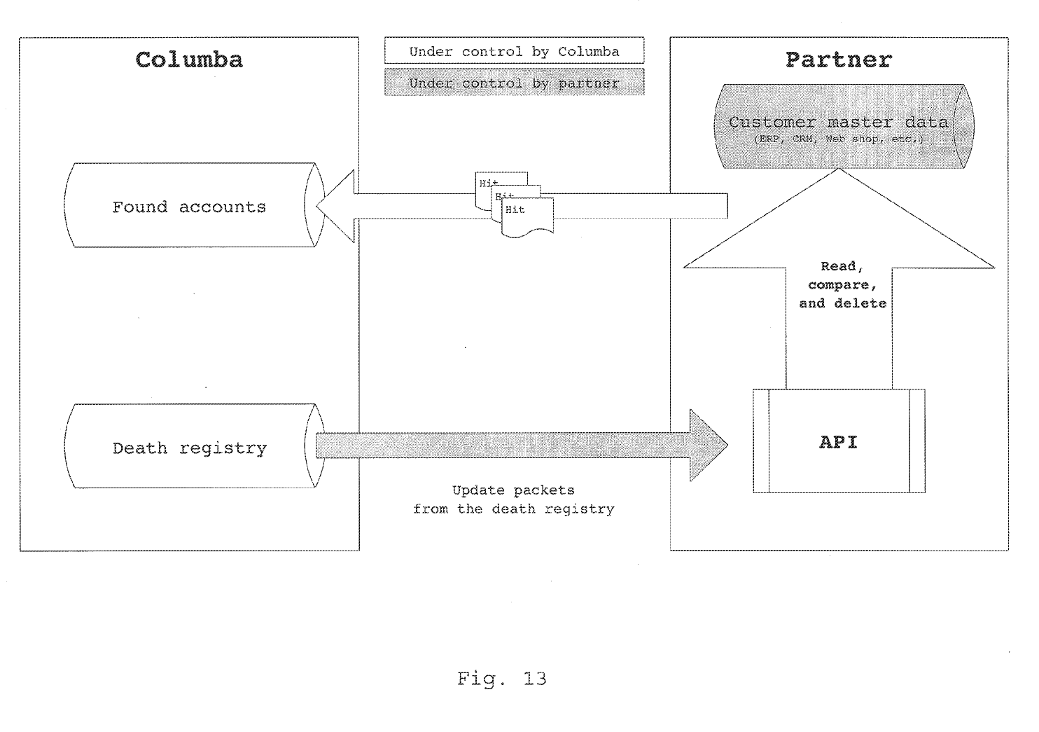

FIG. 13 illustrates variant 3.

Like above, with the difference that Columba does not send the death data to the partners actively; instead the partners retrieve them from the Columba database (since the last reconciliation) and determine the time of the reconciliation. The hits are transmitted back to Columba.

Variant 4—Passively at the Customer Site without Columba API

Data reconciliation is started passively by customer inquiry, and reconciliation is performed at the customer site.

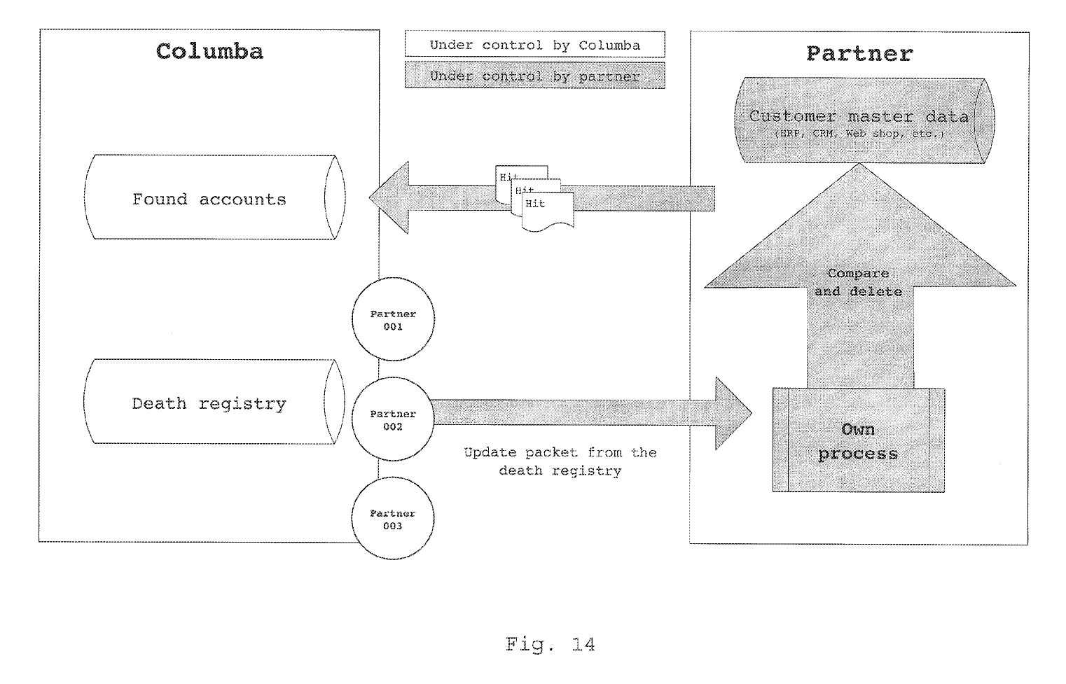

FIG. 14 illustrates variant 4.

An updated file (CSV or similar) of the death data (only new data sets since the last update) is created at firmly defined intervals. To increase security, this file can already be filed here in the file system in encrypted form.

A link to this file is then replicated in the partner directories (virtual hosts), which are created for the partners at registration, so that every partner has access to this file through its own Columba directory. The partner has exclusive read permission to this directory. This ensures that only Columba data are present in the file system. After the data are retrieved, the link from the partner directory is deleted so that the partner can only retrieve current data.

Variant 5—Passively at the Customer Site with Columba Black Box

Data reconciliation is started passively by customer inquiry, and reconciliation is performed in a Columba black box at the partner site.

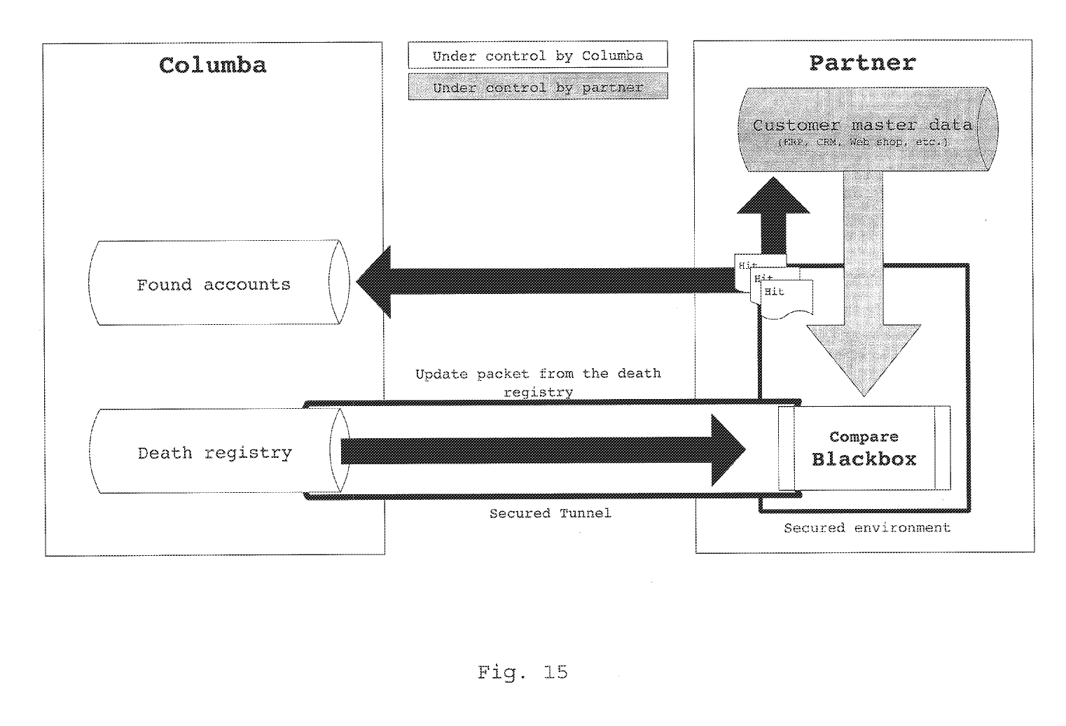

FIG. 15 illustrates Variant 5.

Idea: Two partners should compare lists with each other without one party disclosing its own list to the opposite side.

No data sets of deceased persons are transmitted to the partner in plain text. Furthermore, the partner's customer master data are not disclosed to Columba, with the exception of matching data sets.

The procedure of reconciling the data sets will take place under Columba's control and according to its methodology, both to ensure the quality of the reconciliation and to log that a reconciliation has actually been performed.

The procedure described by Columba corresponds to a black box, into which both sides introduce their lists independently. The Columba lists are introduced in encrypted form and can only be read by the black box.

As a result, the partner is not technically capable of reading the transmitted data, even if it intercepts the data exchange with the black box. A separation of autonomies is planned in order to obtain the partner's trust for the procedure. The logical autonomy over software and encryption lies with Columba, while the autonomy of the hardware remains with the partner.

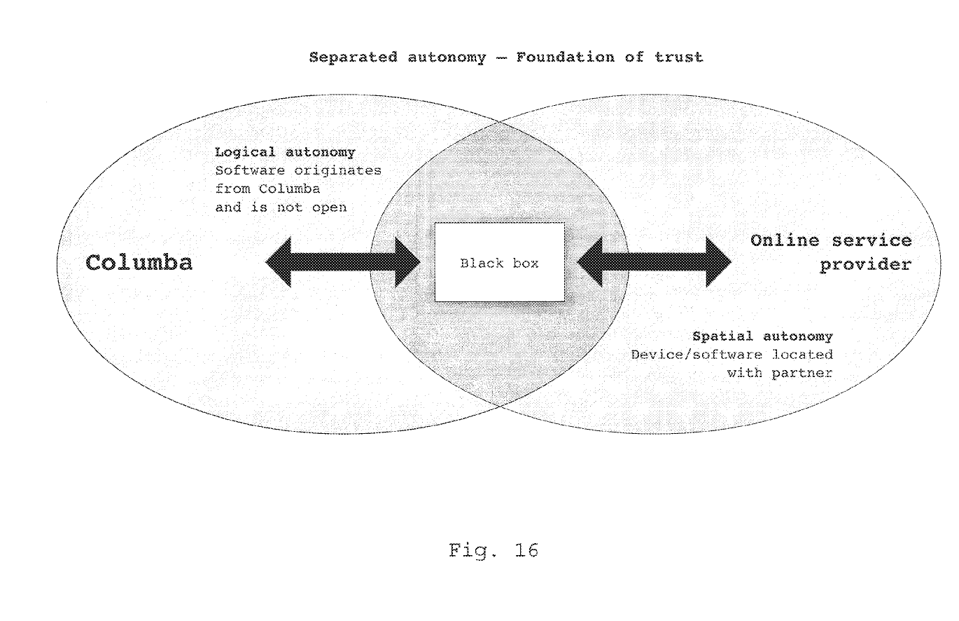

FIG. 16 illustrates the concept of separated autonomies.

It is to be noted that the black box can be realized in its own hardware, which is provided to the partner. However, the black box can run just as well on the partners' systems as software, which brings with it significant logistical simplifications and reduces costs.

However, in any event the partner must register through Columba as a basis for a certification according to the Columba standard. In the converse argument, this means that the reconciliation with the Columba death registry is only possible for known, registered partners. This is ensured by a check for validity performed through the black-box certificate during reconciliation.

The partner is informed as soon as Columba (in definite cycles) has updated data on hand. At that point, the black box will initiate the data reconciliation (manually or automatically) at the partner site: The black box creates a data connection to Columba and retrieves the current database in a suitable format (for example CSV, XML, etc.). The database is encrypted so that the data cannot be read by the partner. As soon as the data are received, the black box notifies the partner and the partner sends its database to the black box in the form of a suitable file (or in a directory in its file system).

The black box recognizes the receipt of new data and starts the reconciliation. The result, in the form of matching hits, is transmitted to Columba and the certified partner in a suitable format. In this way, it is ensured that the partner only obtains knowledge of data that it also has in its system. All additional data from the Columba necrology are permanently deleted by the black box after the reconciliation. With the transfer of the data, these data are identified as transmitted in the Columba register. As a result, the partner reports the status of the data sets concerned back to Columba via an API at Columba (data set ID, status code, date of deletion).

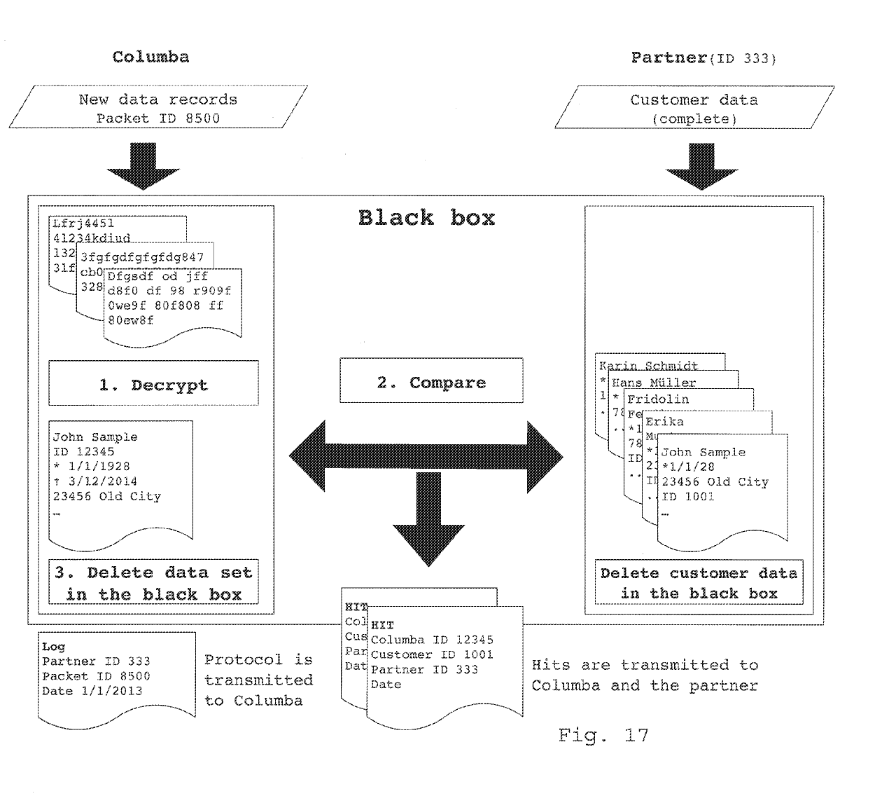

FIG. 17 illustrates the Black box procedure

Variant 6—Passively at the Customer Site with Software Engineering

Data reconciliation is automatically started cyclically; reconciliation is performed at the partner site by means of a server expansion/a certified software module.

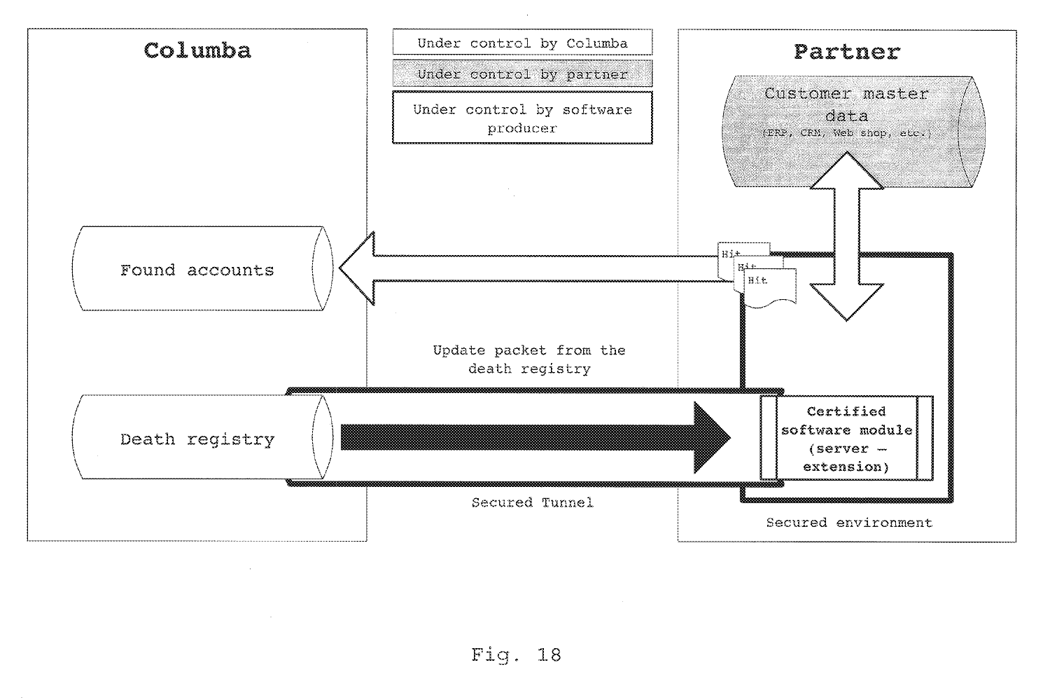

FIG. 18 illustrates Variant 6

To a large extent, this variant is based on the preceding variant (black box) with the difference that, instead of a black box, a certified software module is used that originates directly from the maker of the CRM, ERP, or online shop software. This module accepts the update packets from the Columba death registry in encrypted form.

Because this involves an expansion of the software used locally at the partner site, this variant is able not only to reliably recognize data sets, but also to directly mark detected hits as deceased in the online platform's customer base.

The intention is to move market-leading providers for Web shops and CRM systems to offer their customers an expansion module that automatically takes over the reconciliation with the Columba database in the background. In this case, the reconciliation would not depend on an action by the partner, but could be started automatically in planned cycles.

The software modules described must by certified by Columba; otherwise the module cannot receive any deceased persons' data from Columba. The type of encryption and protocol in which the data is transferred to the software module is predetermined and reviewed by Columba. The module may not file the deceased persons' data locally in unencrypted form or disclose them to the partner. This module has a very similar function to the black box described above.

The partner is continuously informed of changes in its customer base and therefore has the necessary control over the procedure.

This variant is based on both the online provider and Columba having adequate trust in the software producers as independent third parties. The required trust in the software producers can be created by clearly specifying the interfaces and a guaranteed right to access the software's architecture and source code (right to audit).

The procedure is not limited to systems in which the online operator has direct access to its systems; it can also be realized in the offerings of Web shop providers and other service providers who host online platforms for third parties. There, the certified partner should also be offered the option to “reconcile with Columba” when compiling the Web offering.

Self-Registration with Columba

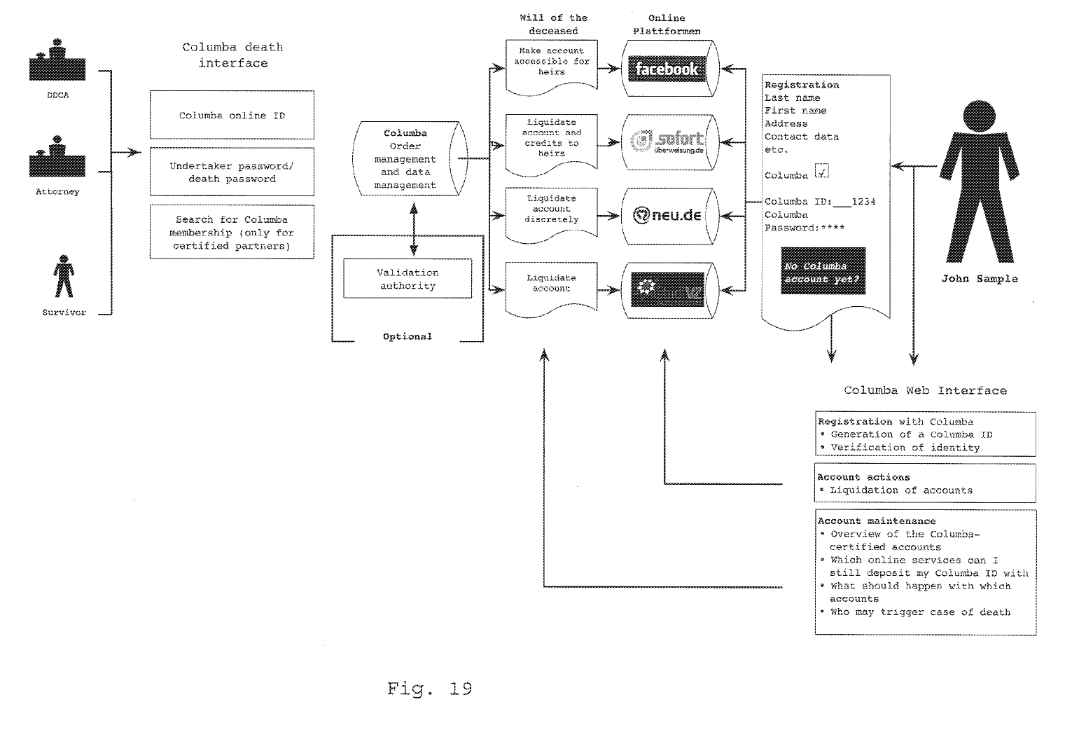

FIG. 19 illustrates the process of self-registration.

Self-Registration with Columba (Online ID Management)

The option exists of opening a Columba account while still alive. The goal is to provide the user a platform on which he/she can administer his/her own online accounts with Columba-certified partners.

Registration

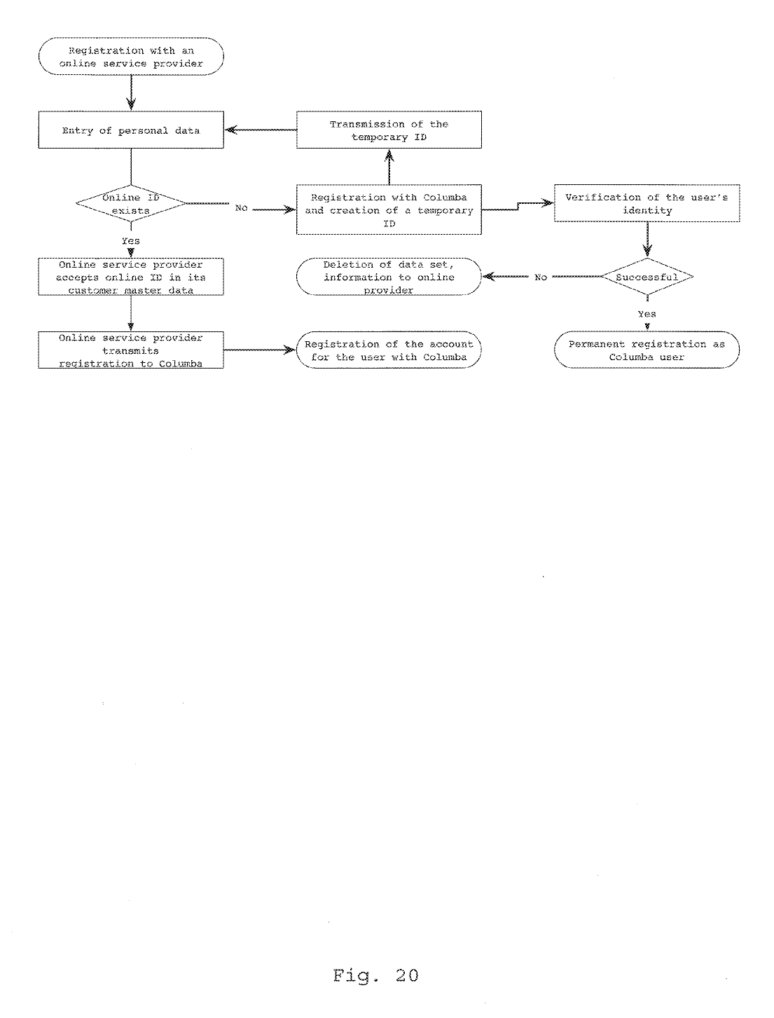

FIG. 20 illustrates the process of Registration.

If a user registers with a certified online service provider, he/she will already be asked for his/her Columba ID as part of the registration. If he/she does not have such an ID, he/she will be referred directly to Columba's registration site. There, a “temporary” Columba online ID can be generated immediately.

In a suitable procedure, Columba will review the identity within the required framework. This information, which has then been certified, can if necessary also be used for the registration with the online service provider itself. (Registration only with Columba online ID; the partner retrieves the additional data from Columba and accepts them in its registration mask.)

For the temporarily created Columba ID, if the identity of the respective person cannot be verified (e.g. via an ID procedure) within a defined period of time, the account is deleted and the certified partners are informed of this.

Following registration with the online service provider, this provider transmits the entered Columba ID to Columba. If the ID is correct, Columba confirms this to the partner and records the information in the Columba data management. The online provider also accepts the Columba online ID in its customer data.

A suitable procedure is implemented to prevent incorrect entries of the Columba online ID. This can be secured with a PIN, for example, or the owner of the entered Columba online ID is informed of the registration by e-mail. It is hard to imagine why anyone would use another person's Columba online ID for his/her own online account, but if this happens nevertheless, the authorized user can use a very simple procedure to delete the registration.

Digital Estate Administration

For all accounts registered with Columba, the user him-/herself can define what should happen in the event of his/her death. In the process, he/she chooses from predefined categories such as:
a. Cancel account
b. Restore assets to heirs
c. Transfer account to heirs

Whereas, depending on the online provider, certain options are not offered for certain account types, or only one option is available (e.g. online accounts with monetary values can only be given to the heirs). However, depending on the online provider, there will always be a “default” setting, which is already displayed to the user at registration.

Maintenance of Accounts

The user can always use the Columba Web interface “Online ID Administration” to look up which Columba-certified online providers he/she has accounts with. Columba registrations can be deleted at any time.

If necessary, the dissolution of the accounts can be initiated via a direct link to the provider. In this way, the “right to be forgotten” is taken into account.

Death

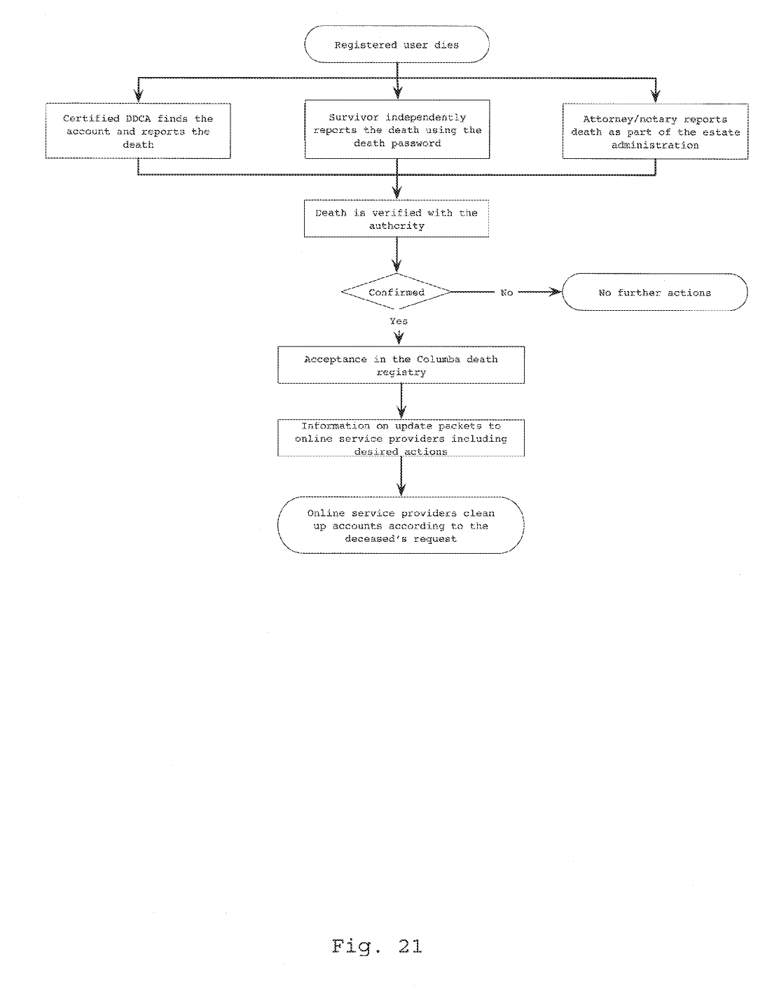

FIG. 21 illustrates the Death diagram.

If death occurs, an event is required to initiate the Columba process. This can be:
a. The DDCA asks if a there was a Columba membership and if there is a Columba online ID. If the relatives do not know if there was a Columba account, the DDCA can search for the deceased in the Columba database*. If the DDCA finds a Columba account, he/she has the task of reporting the death and initiating the process for the death. The subprocess “validation by third party” follows this entry.
b. A notary/attorney starts the process in a Web interface, since this desire was formulated in the deceased's estate administration and the “death password” is available. An attorney (e.g. specializing in inheritance law and estate administration) can also be given the option to search* if he/she is appropriately certified with Columba.
c. A survivor has the “death password” and initiates the process in a Web interface.
d. A responsible authority informs Columba of the person's death. However, here it must be clarified why the authority has the Columba ID, or how agreements should be determined.

Note on search to prevent abuse:
a. No lists can be generated.
b. The Columba account is only confirmed if the search criteria entered display an unequivocal hit. No further data on the deceased are transmitted.
c. All search queries are logged. An especially high number of queries by individually certified sites or cumulative queries that do provide a hit but do not result in a death report are investigated.
d. The deceased's Columba online ID is not announced before an official confirmation, should this be necessary at all.

After the death is validated by the authority, the following steps occur:
a. The deceased will be transferred from the “database of living people” into the death registry with the Columba ID to find the accounts that he/she had with certified partners that nevertheless were not registered.
b. The following function is added to the black box: First there is a check to see if the Columba online ID is also known to the online provider. If this is the case, the hit is 100% confirmed and no address reconciliation is performed. If the Columba online ID is not known or was not transferred with (empty), the “default” actions are introduced.

Conclusion

It can be assumed that the path of registering as “living” will lead to a “critical mass” in the databases significantly faster than the path of the deceased. The mode of action of this procedure is considerably higher, since it can be assumed that 100% of all registered accounts will be found and the wishes of the deceased will be treated accordingly.

Security and Confidentiality

The entire design of the project (Columba) relies in essential parts on a continuous and effective security concept. The process model is based on trust, which must be ensured through a coherent concept and explained and demonstrated to the participants. The result must incorporate an unbroken chain of trust between all process steps and process participants.

It must be ensured that
a. The authenticity of the data is guaranteed over the entire process
b. Unauthorized persons are prevented from accessing sensitive data
c. The documentation requirements based on legal obligations are met
d. Legal data protection requirements for saving, evaluating, and transmitting personal data are taken into account
e. Internationally very heterogeneous conditions and requirements can be taken into account in the procedure.

Stakeholders

Columba must take into account the “stakeholders'” interests and requirements regarding security and trust. The following needs can already be recognized in the conceptual phase:
a. Columba
   A goal is to grow the database quickly, since only in this way is the service attractive to certified online providers. Therefore it is in Columba's interest to be able to use the data obtained permanently.
   Securing the data against access by unauthorized persons and ensuring that the data are not falsified supports its main interest. There is no interest in passing on “necrologies” openly and unencrypted, since this information represents Columba's essential operating capital and must not be made available to the “competition.” Compromised data from deceased persons, no matter what stage of the process and who is to blame (even if errors occur with third parties) lead to a loss of reputation and trust for Columba, which is however an essential characteristic of the business design.
b. Survivors
   A particularly important interest of the relatives is that the data left to Columba are not used for any other purpose than the one agreed upon (e.g. no transmission to third parties for advertising purposes). If credits or other assets are discovered in the course of the service performed by Columba, the relatives have a great interest in reliability (who ensures that no one profits “en route”?) and, if necessary, discretion (money of unknown origin is found in foreign accounts).
   Comment: Of course, the wish for discretion can only be respected within the context of valid legislation.
c. Users who registered while alive
   Personal data on file and registered accounts with online service providers may not be passed on to third parties without the user's knowledge and consent. Because “sensitive” accounts should also be put on file and maintained, it is extremely important that the data are not made accessible to third parties. The “death case” must not be triggered while the person is still alive, which would result in the erroneous deletion of accounts.
d. DDCA
   The DDCA expects a reliable and documented handling and documentation of his/her own services, since these ensure his/her primary commercial interest in the Columba services.
e. Authorities
   Authorities must first fulfill their legal assignment. At the same time, involved authorities will orient themselves significantly on the legal foundation for the processing of the accruing data. On their side, the authorities have a far-ranging interest that every piece of information they provide is binding and error-free.
f. Certified partners
   The partners who obtain certification with Columba do this to demonstrate to their customers that they respect their customers' personal rights even after death. However, as a rule, the partners will not indicate much willingness to make their customer bases accessible to third parties, since this is the foundation of their business. Furthermore, it is very important to the partners that the information on the death is correct and that there has been no confusion of identities. A mistakenly closed user account would represent significant damage to the certified partner's reputation on the market and for the integrity of its own databases.

Actions

In order to be able to serve the large number of interests and demands, some actions are to be provided as foundations in the process model. From this, a documentable and continuous chain of trust can be derived for all participants.
a. All statements on data made by the survivor are reviewed by the recorder (DDCA) for plausibility and authorization. He/she already does this today in the same form and with the same responsibility in a number of questions involving the funeral. He/she knows the local regulations and the authorities' documents.
b. Data and the necessary attached documents are already provided with a digital signature when they are created, which means that it is not possible to change the information later without this fact being detectable and provable.
c. At every sub step, data are transferred exclusively in encrypted form. The partners identify/verify themselves to each other at every process step with the help of digital certificates. Customary and standardized procedures are used to do this. Because these technologies are subject to constant change, such standards should be determined as part of the realization and should be re-examined at regularly defined intervals.
d. All central systems are operated in a secure environment. The computer centers/infrastructures used have an internationally recognized security standard with regard to physical, logical, and organizational security.
e. To the extent required, the system logs all activities of the involved systems reliably and in a tamperproof way. These records also serve the reviews of the systems, which must be performed continuously (if possible, by independent sites).

Certificates

Certificates ensure the identity of the process participants to the process partners. With the help of these certificates, authorizations can be awarded securely and certain resources can be secured against use by unauthorized parties.

The distribution of certificates requires, without exception, that the participating parties accept a superordinate certification site. It is assumed that, if there is sufficient trust in the certification site, trust can also be put in the identity of a certified person/organization. In the process, it must be decided if a public or a process-oriented certificate is needed.
a. Public certificates are always necessary when the unequivocal identification of the site to be certified cannot be performed independently and a third site is required to do this. For this purpose, the market offers available certification sites that correspondingly issue recognized certificates. If the identity of the process participants must also remain verifiable outside their own business processes, a public certificate from an accredited site is urgently recommended (see also Pages of the Federal Network Agency).
b. An internal certification within the process model can be performed by Columba itself if the one-time secure identification of the certified sites (e.g. DDCAs) can also be done process-internally.

Digital certificates can be issued to persons or servers. In the process, the certificate will be present in the form of a file, which can however also be tied to media like smart cards, dongles, or other USB devices. In this way, security is increased again, since the certificate can be copied only by the issuing site.

A hardware-based certificate (dongle, smart card, etc.) supports higher security requirements than a software-based certificate, since use requires a combination of knowledge (pass phrase) and possession (dongle, smart card) to enable access to protected resources. Access cannot be passed on without authorization (lack of hardware) and stealing the necessary hardware also does not make access possible (lack of pass phrase).

Required Certificates

Process participants are to use certificates that are recognizable to each other. Therefore, it is suggested that the digital certificates be created at an accredited certification site. The process participants themselves are responsible for their procurement and extension; they represent a condition for cooperation. However, Columba announces certification sites that are recognized. The certification sites consider the current algorithms to be secure for about the next 7 years. The advances in development of the security architecture require an annual review of the security architecture.
a. Columba
   Columba's identity must be documentable and reviewable for all process partners who transmit data to Columba or receive data from it.
b. DDCA
   The DDCA (explicitly the site that responsibly adds the orders) must be identified unequivocally, firstly because it must be ensured who issued the order (settling) and also whether this order is even suitable for the advance checking of an application. For this purpose, his/her identity must be ensured.
c. Authority's interface/Checking instance
   Since all orders are reviewed against the responsible authorities, it must be ensured that the data are transmitted to the responsible site, and only to this one.
d. Partner
   All the partner's responses regarding actions that were performed with found accounts are to be reliably assigned to the partner with a certificate.
e. Black box/Software module Because the entire lists of deceased people are transferred to the black box/the software module, the receiver must always be unequivocally identified during transfer. The transferred data can only be decrypted against the certificate that is firmly integrated in the software. The certificate also cannot be freed and transferred from the black box/the software module.

Encryption

Every communication between the participating systems (e.g., DDCA, registered user, survivor, Columba, authorities, and certified partners) should be protected whenever personally or commercially important data are transferred. This can be achieved via an encryption of the data transfer and data storage and ensures the following:
a. Confidentiality of the data (Confidentiality)
   No unauthorized party can monitor and read the data
b. Integrity of the data transfer (Integrity)
   The data was not manipulated in the transfer
c. Authenticity of the data (Authenticity)
   The source/origin of the data transfer is ensured

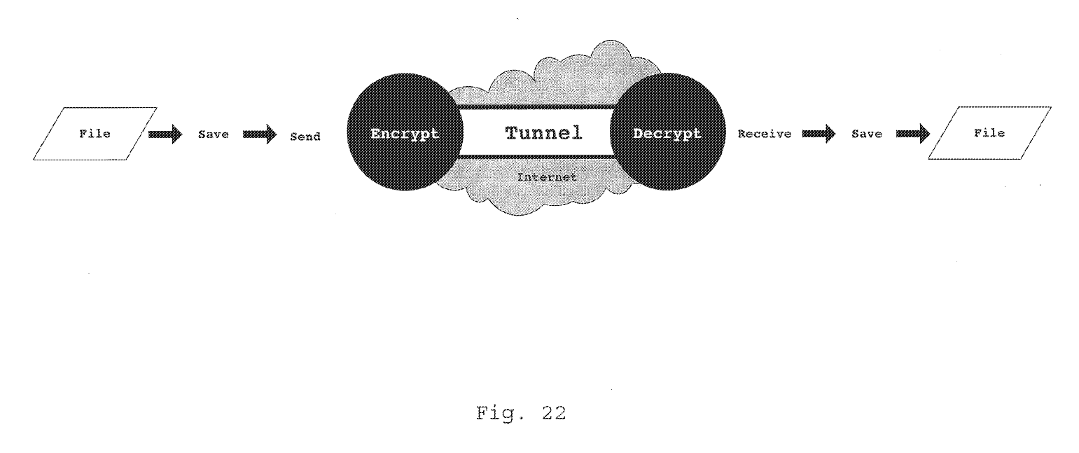

In the process it must be decided if:
a. The transport route as such should be secured by using a secure transport protocol such as:
   i. SSL, e.g. session-based https:
   ii. proprietary protocols
   iii. IPsec, e.g. site connections.
b. In this way, the exchange of data can be managed securely. In the process, both end points of the communication are seen as a “secure environment,” within which data do not need to be secured.
c. FIG. 22 illustrates the Encrypted tunnel.
d. The goods in transit should be secured. To this end, data is encrypted in a predetermined file format and correspondingly saved. In this way, security is created even if the end points themselves are not considered secure, because, for example, other non-authorized persons have access to the saved data.

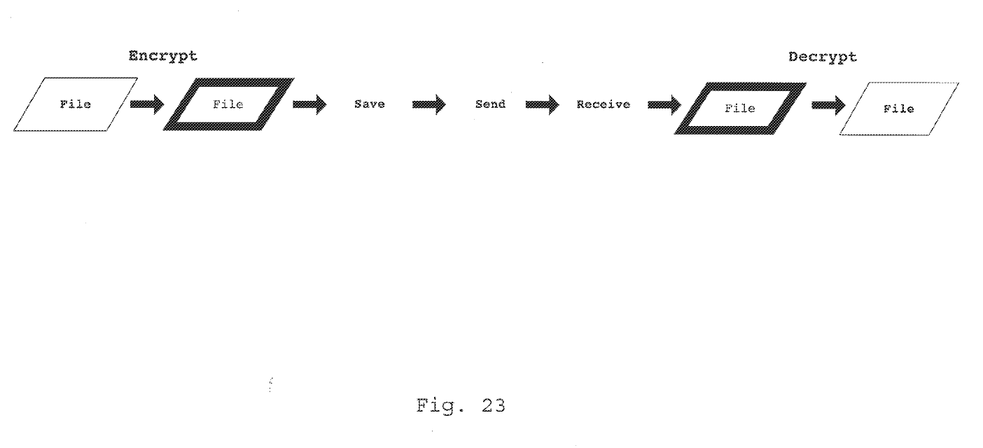

FIG. 23 illustrates the concept of Encrypted file.

Requirements for Encryption
a. Transfer DDCA-Columba
   i. Confidentiality: Medium-High
   ii. Integrity: Very high
   iii. Authenticity: Very high
b. Transfer Columba-authority-Columba
   i. Confidentiality: Medium
   ii. Integrity: Very high
   iii. Authenticity: Medium-High
c. Transfer order management-data management
   i. Confidentiality: Low (in-house)
   ii. Integrity: Very high
   iii. Authenticity: Low (in-house)
d. Transfer death registry-black box
   i. Confidentiality: Very high
   ii. Integrity: Very high
   iii. Authenticity: Very high
e. Transfer partner-black box
   i. Confidentiality: Low (in-house)
   ii. Integrity: Very high
   iii. Authenticity: Medium (in-house)
f. Transfer black box-Columba
   i. Confidentiality: High
   ii. Integrity: Very high
   iii. Authenticity: Very high
g. Transfer black box-Columba/partner
   i. Confidentiality: Low (in-house)
   ii. Integrity: Very high
   iii. Authenticity: Medium (in-house)

Signature

The objective of the service offered by Columba is, after discovering online accounts of deceased persons, to introduce actions such as e.g., the liquidation or deactivation of these accounts. The authenticity of the saved information and, if necessary, the saved documents must therefore be ensured. For this purpose, the documents must be provided with digital signatures that absolutely certainly and permanently document:

The source (creator) of the document

The vulnerability of the document

For the order data, this results in the need to save the collected data in a file (file for example in PDF or XML format) after the conclusion of the order creation and at the same time to provide the file with a digital signature.

The same thing will happen in the registration of data recorded by DDCAs and partners.

Mode of Operation

After the data have been entered and transferred to Columba, the data are summarized in a file of a suitable format and provided with a digital signature. This signature is generated from a private signature key (PKI) from Columba and a clear calculation specification. In the process, a collision-free hash value is created via the document (no two documents give the same hash value), which together with the private key is used to create the digital signature.

At a later time, the creator, as well as the integrity of the document, can be proven against the DDCA's public key (deposited with the certification service provider).

If a signature according to the standard of the “Qualified digital signature” is required for the application, the detailed planning phase should be reviewed and examined with reference to the legal background. However, this appears to make sense for the application in Germany.

### Proof of Concept, an Example

John Sample, an open-minded and average man in his mid-sixties, born on Jun. 17, 1947, in Sample City, died suddenly and unexpectedly on Jun. 3, 2011, in a traffic accident without leaving behind a will. Both of his children know that their father was “rather active on the Internet.” They know for certain that he handled his banking affairs with online banking and bought and sold many objects on eBay. To handle the purchases on eBay, he registered with PayPal, where he leaves behind a credit of Euro 350.00. To keep in touch with his nieces and nephews in the USA, he also created accounts with Facebook and Skype. With Skype, he still has a small credit for landline conversations to the tune of Euro 15.75. For his communication and his memberships, John used the e-mail address of his telephone provider; john.sample@t-online.de.

What neither John's children nor his wife knew is that in his free time John sometimes liked to gamble online and that he put some of his winnings into stock trades. John never risked especially high amounts, but over the course of time he accumulated 12,000 euros, and his Puma and Lufthansa shares, which he purchased for 8,000 euros and which he managed with his online bank “Coral Condors”, are now worth more than 18,000 euros. Because in the past John and his wife used the same e-mail address and his wife can read all his e-mails, John preferred to use his own e-mail address for his small private transactions. He therefore created the e-mail address john.sample@gmx.net, which he used to carry out his financial transactions.

Looking for help, John's family turns to the undertaking company Denk with the question of how they can “delete” John's Facebook, eBay, and PayPal accounts and how they can obtain the money left there. They also want notices of John's approaching birthday to finally stop, since they already have enough to do with their mourning and many bureaucratic matters. They cannot give the DDCA much more information since none of John's relatives know his password or know where he could have stored it.

The Denk employee offers the Sample family the company's new product, which can find John's online identities and, if necessary, also delete them. Under certain circumstances, credits that still exist can also be reimbursed, insofar as they are available. This service would be handled by the DDCA's partner “Columba.” However, a processing fee would have to be retained from the remaining assets for each account. He/she explains to the Samples that it can “take some time” for the memberships to be found. Unfortunately, until then they might still receive e-mails or letters for John.

The Samples agree and give the undertaking company the order. The DDCA begins work immediately and enters John Sample's data into the Columba software's input mask, which he/she has installed on his/her computer. He/she received the software in the mail after registering as a partner on Columba's Web site and Columba verified that he/she is a registered undertaking company.

He/she enters John Sample's first name, last name, place of birth, place of death, and last address. After reviewing everything thoroughly, he/she sends the order to Columba. John Sample's data are sent to Columba in encrypted form with the help of a dongle that must be inserted when the software is used and contains a digital certificate. In this way, it is ensured that unauthorized persons can neither send data to Columba nor view data.

Now John's data are with Columba in order management. Since the possible damage that accidentally false, intentionally falsified, or improperly entered data can cause for a living person is very great, the information must be reviewed for correctness. The authority that manages the death registry can reliably confirm this information. In Germany, these are the responsible registrar's offices, as well as the registry offices (Framework Registration Act). Since the introduction of the electronic population register, under the requirements of the appropriate laws, these authorities also issue electronic information on personal data (simple and expanded register information). Columba uses this mechanism by transmitting the data from the DDCA to the responsible authority for confirmation.

Should the data of a deceased person that were transmitted by Columba to the authority lead to an unequivocal match there, the authority confirms the information. Since there must be a check to confirm that the reported person is really deceased, the so-called “expanded register notice” is needed, which contains the date of death.

From this point in time, the data are officially validated and are routed from order management to data management. Since order management and data management are in fact separate systems, but are physically in the same data processing center, data can be transferred over a direct connection without using the Internet, and are therefore adequately secured in the context of the standards in the data processing center.

From this time, John Sample's data, consisting of first name, date of birth, last address, and date of death, are sent to the online providers at cyclical intervals for reconciliation, which are currently still managed under the term black box and which either stand as independent computers in the partner's data processing center or run on the partner's available hardware as a software module, which was provided to the partner by Columba. The purpose of the black box (and therefore also its name) is to reconcile data that should not be visible to any of the business partners, since, for security reasons and also because it is a trade secret, Columba does not want to reveal its database, and also because the partners want their own databases to be treated the same way. Therefore, data are transmitted to the black box in encrypted form. The black box is able to decrypt the received data, reconcile them, provide them with the appropriate statements (hits), and re-encrypt them. Only the list of hits will be transferred back to Columba and into the partner system.

As soon as the partner company has received the list of hits, it can perform additional steps, e.g. delete the affected account, deactivate, etc. For this, the partner's usual procedures apply. To further inform Columba what happened with the account or which additional information is meaningful (e.g. that there is still a credit on the account), the partner can report back the respectively updated status of the processing. This is done using the Columba ID, which was transmitted to the partner from the black box. In this way, the confirmation can be transferred without any personal data.

If the certified partner reports a credit status, the Columba debt collection can become active and return the credit to the survivors. John's heirs can decide if they want to continue the account that has been found or if they want to sell the shares deposited there and have the proceeds paid out minus the processing fee.

Now Columba knows that John Sample had accounts with eBay, PayPal, Facebook, and Skype, but also with www.pokerstars.com, Coral Condors, and gmx.net (including all credits and shares). Conversely, all the named partners know that the account holder John Sample is deceased and can introduce the appropriate measures. As a rule, they will be legally obligated to deactivate the accounts and return credits.

Furthermore, the Columba data management also knows the time at which the partners performed the reconciliation and will not send John Sample's data to the black box again for the next reconciliation. In this way, both the transported data volume and the duration of the reconciliation are reduced.

In addition, the partner companies have now been informed of their member's death and, in case of automatically renewable contracts/memberships, can no longer invoke their lack of knowledge regarding the fact that their member is deceased.

### ABBREVIATIONS, GLOSSARY

| | | |
|---|---|---|
| a. | DB | database |
| b. | PC | personal computer |
| c. | PKI | public key infrastructure |
| d. | API | Application Programming Interface |

Database System

To implement data management, it is necessary to determine the software environment in which the system should be realized. This includes the database management system (DBMS), the programming language for the interfaces to the database and the required HTTP server, which will be used to access the data management system.

Database Management System

A suitable database system is necessary to permanently save large databases, find data again according to arbitrary criteria, and to change data. In the process, database systems cover various tasks:

Data are saved in a common database (the database)

Takes over access to data and its representation

Monitors and restricts access to the data

The database system thus consists of a database (DB—database) and a database management system (DBMS).

The database is accessed exclusively via the database management system's “filters.” At its interface, a database system provides a database language (query language) for the following purposes:

To configure the structure of a database (data definition)

To record, change, and delete data sets (data manipulation)

To obtain information from the database (data query)

To administer entry and access rights (data control)

To secure, export, and import data (data transfer)

Overview of DBMS available today from different manufacturers and the underlying database model

| Manufacturer | DBMS | Model |
|---|---|---|
| Borland | InterBase | relational |
| IBM | DB2 | object relational |
| IBM | IMS | hierarchical, mainframe—DBMS |
| IBM | Informix | object relational |
| InterSystems | Cache | hierarchical |
| Microsoft | MS Access | relational, desktop system |
| Microsoft | MS SQL Server | object relational |
| Microsoft | Visual FoxPro | relational, desktop system |
| MySQL AB | MySQL | relational |
| NCR Teradata | Teradata | relational high-performance DBMS |
| ORACLE | Oracle | object relational |
| Software AG | Adabas | NF² model (not normalized) |
| Sybase | Sybase ASE | relational |
| Versant | Versant | Object-oriented |

Programming Language

The programming language in which the database's interfaces are implemented must offer a programming interface (API) to the database used and should allow for the requirements set out above

1. An online ID-handling computer system, comprising at least one of the following modules:
a. a death data register;
b. a first module which validates data;
c. a second module which verifies data with respect to a deceased person, by a request directed to an agency for collecting deceased's data;
d. a third module which takes the data into the death data register,
e. a fourth module which establishes a number of update data packages which comprise the data taken over;
f. a fifth module which initiates comparison of update data packages with data of a number of online providers;
g. a sixth module which receives matches which are found during comparison with the online providers;
h. a seventh module which generates a log concerning the comparisons;
i. an eight module which initiates data processing operations with respect to the data of the deceased persons with those online providers where matches have been found;
j. a ninth module which displays matches;
k. a tenth module which links together deceased's data, data of an agency for collecting deceased's data, and matches;
l. an eleventh module which transmits data using a proprietary protocol; and
m. a twelfth module which encrypts data using a proprietary encryption method.

2. A computer system adapted for executing a method of processing data relating to a deceased person, the computer system comprising:
a. a reception module which receives order data from a survivor of the deceased person;
b. an administration module which verifies the order information and receives further data relating to the deceased person and to the survivor, the administration module being coupled to the reception module;
c. a transmission module which transmits the data to the online ID handling computer system of claim 1.

3. The computer system of claim 1, further comprising an encryption module which encrypts data to be transmitted.

4. The computer system of claim 3, wherein the encryption module uses a proprietary file format and a proprietary protocol.

5. The computer system of claim 1, further comprising an authentication module which authenticates data to be transmitted.

6. The computer system of one claim 1, wherein data to be transmitted comprise personal information descriptive of:
Academic title;
First names and last name;
Gender;
Place and date of birth;
Date of death;
Address of the last residence
Nationality;
An online ID, if available.

7. The computer system of claim 6, wherein data to be transmitted comprise personal information descriptive of:
Tax number;
Debtor number;
Identification number.

8. A computer-implemented method of processing data of a deceased person, comprising at least one of the following steps:
a. receiving order data from a survivor of the deceased person;
b. verifying the data and receiving further data relating to the deceased person and to the survivor;
c. transmitting the data to the online-ID-handling computer system;
d. validating the data;
if the data is not correct, turning back to step b;
verifying the data concerning the deceased person with an authority;
if the verification fails, turning back to step b;
taking over the data into a death register of the online-ID-handling computer system;
e. establishing a number of update data packages which comprise the data taken over;
f. initiating comparison of update data packages with the data of a number of online providers;
g. if during comparison matches of data are found, transmitting the matches to the online-ID-handling system;
h. generating a log concerning the comparisons
i. initiating data processing operations with respect to the data of the deceased person with those online providers where matches have been found.

9. The method of claim 8, further comprising a step of encrypting data to be transmitted using a proprietary method.

10. The method of claim 8, further comprising a step of authenticating data to be transmitted

11. The method of claim 8, further comprising a step of displaying matches.

12. The method of claim 8, further comprising a step of linking together deceased's data, data of an agency for collecting deceased's data, and matches.

13. The method of claim 8, further comprising a step of transmitting data using a proprietary protocol.

14. The method of claim 8, wherein data to be transmitted comprise personal information descriptive of:
Academic title;
First names and last name;
Gender;
Place and date of birth;
Date of death;
Address of the last residence
Nationality;
An online ID, if available.

15. The method of claim 14, wherein data to be transmitted comprise personal information descriptive of:
Tax number,
Debtor number;
Identification number.

16. A data carrier comprising instructions which when loaded into a computer system, control the computer system so as to perform the method according to claim 8.

17. An online ID-handling computer system, comprising:
a. a death data register;
b. a first module which validates data;
c. a second module which verifies data with respect to a deceased person, by a request directed to an agency for collecting deceased's data;
d. a third module which takes the data into the death data register,
e. a fourth module which establishes a number of update data packages which comprise the data taken over;
f. a fifth module which initiates comparison of update data packages with data of a number of online providers;
g. a sixth module which receives matches which are found during comparison with the online providers;
h. a seventh module which generates a log concerning the comparisons;
i. an eight module which initiates data processing operations with respect to the data of the deceased persons with those online providers where matches have been found;
j. a ninth module which displays matches;
k. a tenth module which links together deceased's data, data of an agency for collecting deceased's data, and matches;
l. an eleventh module which transmits data using a proprietary protocol; and
a twelfth module which encrypts data using a proprietary encryption method.
